(19) United States
(12) Patent Application Publication
(10) Pub. No.: US 2018/0342008 A1
(43) Pub. Date: Nov. 29, 2018

(54) NON-TRANSITORY COMPUTER-READABLE STORAGE MEDIUM, DISPLAY CONTROL APPARATUS, AND DISPLAY CONTROL METHOD

(71) Applicant: FUJITSU LIMITED, Kawasaki-shi (JP)

(72) Inventors: Kei Sekine, Ota (JP); Gensai Hideshima, Nishinomiya (JP)

(73) Assignee: FUJITSU LIMITED, Kawasaki-shi (JP)

(21) Appl. No.: 15/984,484

(22) Filed: May 21, 2018

(30) Foreign Application Priority Data
May 25, 2017 (JP) 2017-103282

(51) Int. Cl. G06Q 30/06; G06F 3/147; G06T 7/20; G06T 7/70

(52) U.S. Cl. CPC G06Q 30/0641; G06F 3/147; G06T 7/20; G06T 2207/30241; G06T 2207/30242; G06T 2207/30196; G06T 7/70

(57) ABSTRACT

A non-transitory computer-readable storage medium storing a program that causes a computer to execute a process including receiving an image of a floor and a floor map including a plurality of areas included in the floor, displaying the received image and the received floor map on a screen, specifying, upon a reception of a designation of a position in the image, a first area corresponding to the designated position based on correspondence information, the correspondence information indicating a correspondence between a plurality of positions in the image and the plurality of areas, obtaining information associated with the first area from a second memory storing pieces of information in association with the plurality of areas respectively, displaying the obtained information on the displayed image in association with the first area, and displaying, on the screen, information indicating a position of the first area in the floor map.

### CROSS-REFERENCE TO RELATED APPLICATION

This application is based upon and claims the benefit of priority of the prior Japanese Patent Application No. 2017-103282, filed on May 25, 2017, the entire contents of which are incorporated herein by reference.

### FIELD

The embodiment discussed herein is related to a display control program, a display control apparatus, and a display control method.

### BACKGROUND

A company that provides a service for users (hereinafter simply referred to as a “company”), for example, builds and operates a business system (hereinafter also referred to as an “information processing system”) for providing the service. More specifically, the company provides, for example, a service for analyzing the behavior of customers in a store (hereinafter also referred to as “in-store behavior”).

In this case, the business system obtains (generates) information indicating lines of flow of the customers in the store and information indicating stay periods of the customers in each area and outputs the information to a display device used by a user. The user of the service provided by the business system refers to the information output to the display device and optimizes a product layout in a store or develops a new sales method (for example, refer to Japanese Laid-open Patent Publication No. 2001-143184, International Publication Pamphlet No. WO2014/203386, Japanese Laid-open Patent Publication No. 2004-295331, and Japanese Laid-open Patent Publication No. 2016-085667).

### SUMMARY

According to an aspect of the invention, a non-transitory computer-readable storage medium storing a program that causes a computer to execute a process, the process including receiving an image of a floor included in a store and a floor map including a plurality of areas included in the floor, displaying the received image and the received floor map on a screen of a display device, specifying, upon a reception of a designation of a position in the image, a first area, in the plurality of areas, corresponding to the designated position based on correspondence information stored in a first memory, the correspondence information indicating a correspondence between a plurality of positions in the image and the plurality of areas included in the floor, obtaining information associated with the first area from a second memory, the second memory storing pieces of information in association with the plurality of areas respectively, displaying the obtained information on the displayed image in association with the first area, and displaying, on the screen, information indicating a position of the first area in the floor map.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the overall configuration of an information processing system;

FIG. 2 is a diagram illustrating the hardware configuration of an information processing apparatus;

FIG. 3 is a block diagram illustrating functions of the information processing apparatus;

FIG. 4 is a block diagram illustrating information stored in the information processing apparatus;

FIG. 5 is a flowchart illustrating an outline of a display control process according to a first embodiment;

FIG. 6 is a flowchart illustrating the outline of the display control process according to the first embodiment;

FIG. 7 is a flowchart illustrating the outline of the display control process according to the first embodiment;

FIG. 8 is a flowchart illustrating details of the display control process according to the first embodiment;

FIG. 9 is a flowchart illustrating the details of the display control process according to the first embodiment;

FIG. 10 is a flowchart illustrating the details of the display control process according to the first embodiment;

FIG. 11 is a flowchart illustrating the details of the display control process according to the first embodiment;

FIG. 12 is a flowchart illustrating the details of the display control process according to the first embodiment;

FIG. 13 is a flowchart illustrating the details of the display control process according to the first embodiment;

FIG. 14 is a diagram illustrating a specific example of a screen at a time when floor image information has been displayed on a display device of a control terminal;

FIG. 15 is a diagram illustrating a specific example of a screen at a time when floor map information has been displayed on the display device of the control terminal;

FIG. 16 is a diagram illustrating a specific example of line of flow information;

FIG. 17 is a diagram illustrating a specific example of a screen at a time when marks generated in S33 have been displayed on the display device of the control terminal;

FIG. 18 is a diagram illustrating a specific example of a screen at a time when S34 and S35 have been performed;

FIG. 19 is a diagram illustrating a specific example of three-dimensional mapping information;

FIG. 20 is a diagram illustrating a specific example of two-dimensional mapping information;

FIG. 21 is a diagram illustrating a specific example of product information;

FIG. 22 is a diagram illustrating a specific example of POS information;

FIG. 23 is a diagram illustrating a specific example of store object information;

FIG. 24 is a diagram illustrating a specific example of movement history information;

FIG. 25 is a diagram illustrating a specific example of a screen at a time when S52 and S53 have been performed;

FIG. 26 is a diagram illustrating a specific example of line of flow object information;

FIG. 27 is a diagram illustrating a specific example of a screen at a time when S65 has been performed;

FIG. 28 is a diagram illustrating a specific example of a screen at a time when S84 has been performed; and

FIG. 29 is a diagram illustrating a specific example of the screen at the time when S84 has been performed.

### DESCRIPTION OF EMBODIMENT

When the in-store behavior of customers is analyzed as above, for example, a user is desired to simultaneously refer to a plurality of different pieces of information. If the number of pieces of information to be simultaneously referred to is large, however, it is difficult for the user to efficiently refer to relevant information. It is therefore difficult for the user to intuitively understand characteristics of the in-store behavior of customers and conduct an efficient analysis.

An aspect aims to provide a display control program, a display control apparatus, and a display control method for achieving an efficient analysis of characteristics of in-store behavior.

Configuration of Information Processing System

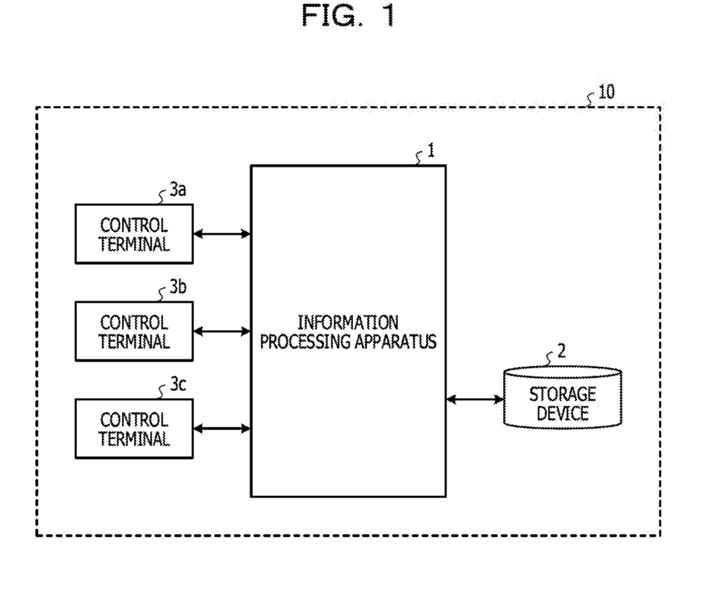

FIG. 1 is a diagram illustrating the overall configuration of an information processing system 10. The information processing system 10 illustrated in FIG. 1 includes an information processing apparatus 1, a storage device 2, and control terminals 3. The control terminals 3 include control terminals 3a, 3b, and 3c in FIG. 1.

The information processing apparatus 1 generates, based on various pieces of information stored in the storage device 2, various screens referred to by the user to analyze the in-store behavior of customers. More specifically, the information processing apparatus 1 generates various screens if, for example, the user inputs, through a control terminal 3, information indicating that the in-store behavior is to be analyzed. The information processing apparatus 1 then outputs the generated screens to a display device (not illustrated) of the control terminal 3.

As a result, the user may optimize a product layout in a store or develop a new sales method, for example, while referring to the screens output to the control terminal 3.

When the user analyzes the in-store behavior of customers, the user is desired to simultaneously refer to a plurality of different pieces of information.

When the user simultaneously refers to a plurality of different pieces of information, however, the user is desired to combine a two-dimensional floor image on which lines of flow are drawn, a three-dimensional image, and point-of-sale (POS) data together, for example, and analyze these pieces of data based on expert knowledge and experience. In this case, it is difficult for the user to efficiently refer to relevant information. It is therefore difficult for the user to intuitively understand characteristics of the in-store behavior of customers and conduct an efficient analysis.

The information processing apparatus 1 according to the present embodiment receives an image of a floor included in a store and a floor map including a plurality of areas included in the floor and displays the image of the floor and the floor map on a display unit (for example, the display device of the control terminal 3).

If a position on the image of the floor displayed on the display unit is specified, the information processing apparatus 1 refers to the storage device 2 storing identification information regarding areas corresponding to positions on the image of the floor, for example, and identifies an area (hereinafter referred to as a “first area”) corresponding to the specified position on the image of the floor. The information processing apparatus 1 refers to the storage device 2 storing information regarding areas associated with the areas, for example, and obtains information associated with the first area.

The information processing apparatus 1 then displays the obtained information associated with the first area on the image of the floor while associating the information with the first area. The information processing apparatus 1 also displays, on the image of the floor, information indicating a location of the first area among the plurality of areas included in the floor map.

That is, the information processing apparatus 1 displays, on the display unit, for example, a three-dimensional image (the image of the floor) indicating a state of the first area corresponding to the position specified by the user among the plurality of areas included in the floor and a two-dimensional image (floor map) indicating a positional relationship between the plurality of areas included in the floor. The information processing apparatus 1 then displays a position of the three-dimensional image (a position of the first area) on the two-dimensional image. The information processing apparatus 1 also displays the information associated with the first area on the three-dimensional image at a position corresponding to the first area.

The information processing apparatus 1 thus enables the user to intuitively understand the position, on the floor, of the three-dimensional image displayed on the display unit. The information processing apparatus 1 also enables the user to intuitively understand the information associated with the first area. The user may therefore efficiently analyze the in-store behavior of customers.

Hardware Configuration of Information Processing Apparatus

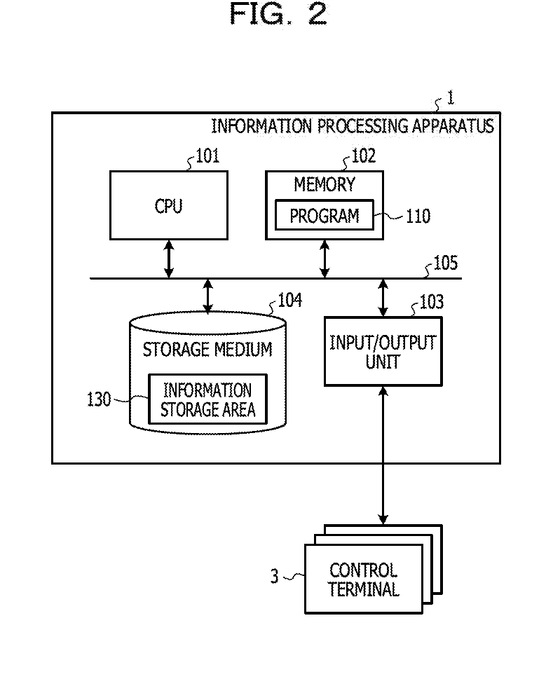

Next, the hardware configuration of the information processing apparatus 1 will be described. FIG. 2 is a diagram illustrating the hardware configuration of the information processing apparatus 1.

As illustrated in FIG. 2, the information processing apparatus 1 includes a central processing unit (CPU) 101, which is a processor, a memory 102, an external interface (input/output unit) 103, and a storage medium (storage) 104. The components are connected to one another through a bus 105.

The storage medium 104 stores a program 110 for performing a process (hereinafter referred to as a “display control process”) for controlling screens displayed on the control terminals 3, for example, in a program storage area (not illustrated) of the line of flow information 140.

As illustrated in FIG. 2, when executing the program 110, the CPU 101 loads the program 110 from the storage medium 104 in the memory 102 and performs the display control process in combination with the program 110.

The storage medium 104 is a hard disk drive (HDD), a solid-state drive (SSD), or the like, for example, and includes an information storage area 130 (hereinafter also referred to as a “storage unit 130”) storing information used to perform the display control process. The storage medium 104 may correspond to the storage device 2 illustrated in FIG. 1.

The external interface 103 communicates with the control terminals 3 through a network.

Software Configuration of Information Processing Apparatus

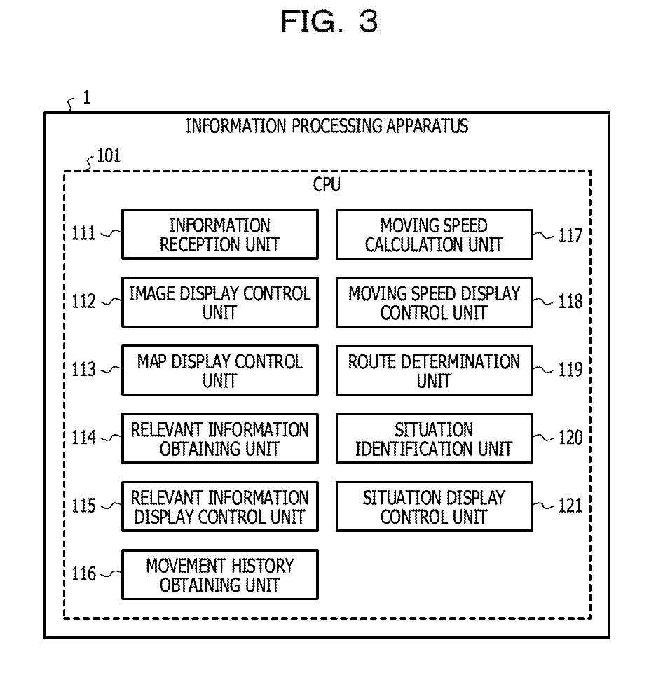

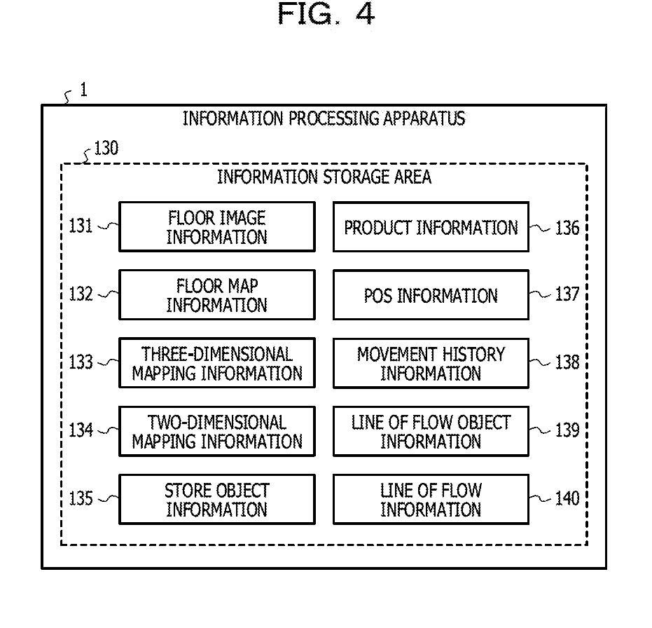

Next, the software configuration of the information processing apparatus 1 will be described. FIG. 3 is a block diagram illustrating functions of the information processing apparatus 1. FIG. 4 is a block diagram illustrating information stored in the information processing apparatus 1.

As illustrated in FIG. 3, the CPU 101 operates in combination with the program 110 to function as an information reception unit 111, an image display control unit 112, a map display control unit 113, a relevant information obtaining unit 114 (hereinafter also referred to simply as an “information obtaining unit 114”), a relevant information display control unit 115 (hereinafter also referred to simply as an “information obtaining unit 115”), and a movement history obtaining unit 116 (hereinafter also referred to simply as an “information obtaining unit 116”). As illustrated in FIG. 3, the CPU 101 operates in combination with the program 110 to also function as a moving speed calculation unit 117, a moving speed display control unit 118 (hereinafter also referred to simply as a “display control unit 118”), a route determination unit 119, a situation identification unit 120, and a situation display control unit 121 (hereinafter also referred to simply as a “display control unit 121”). The image display control unit 112 and the map display control unit 113 will be collectively referred to as a “display control unit” hereinafter.

As illustrated in FIG. 4, the information storage area 130 stores floor image information 131, floor map information 132, three-dimensional mapping information 133, two-dimensional mapping information 134, store object information 135, product information 136, and POS information 137. As illustrated in FIG. 4, the information storage area 130 also stores movement history information 138, line of flow object information 139, and line of flow information 140. The movement history information 138 and the line of flow information 140 will be collectively referred to as a “movement history” hereinafter.

The information reception unit 111 receives an image of a floor included in a store and a floor map including a plurality of areas included in the floor. More specifically, the information reception unit 111 obtains the floor image information 131 and the floor map information 132 stored in the information storage area 130 in accordance with an instruction from a control terminal 3.

The floor image information 131 is images (three-dimensional images) of scenes in a store viewed from certain positions. That is, the floor image information 131 is images (three-dimensional images) of a floor captured at the certain positions in the store. More specifically, the floor image information 131 includes, for example, images captured at a plurality of positions in the store in a plurality of directions. The floor map information 132 is maps (two-dimensional maps) of floors in the store. The floor image information 131 and the floor map information 132 may be stored by the user or the like in the information storage area 130 in advance.

The image display control unit 112 displays, for example, the floor image information 131 obtained by the information reception unit 111 on the display device of the control terminal 3.

The map display control unit 113 displays, for example, the floor map information 132 obtained by the information reception unit 111 on the display device of the control terminal 3.

If a position on the floor image information 131 is specified through the information reception unit 111, the relevant information obtaining unit 114 refers to the three-dimensional mapping information 133 including identification information regarding an area corresponding the specified position and identifies a first area corresponding to the position specified through the information reception unit 111. If a position on the floor map information 132 is specified through the information reception unit 111, the relevant information obtaining unit 114 refers to the two-dimensional mapping information 134 including identification information regarding an area corresponding to the specified position and identifies a first area corresponding to the position specified through the information reception unit 111.

The relevant information obtaining unit 114 also refers to information regarding areas associated with the areas and obtains information associated with the first area. More specifically, the relevant information obtaining unit 114 refers to the store object information 135 including information regarding objects (for example, shelves provided on the floor) associated with the areas, the product information 136 including information regarding products sold in the store, the POS information 137 including information regarding purchase situations of products to customers, and the movement history information 138 including positional information obtained from wireless terminals or the like carried by the customers and obtains the information associated with the first area. The store object information 135, the product information 136, the POS information 137, and the movement history information 138 may be stored by the user or the like in the information storage area 130 in advance.

The relevant information display control unit 115 displays the information obtained by the relevant information obtaining unit 114 on the floor image information 131 displayed by the image display control unit 112 while associating the information with the first area identified by the relevant information obtaining unit 114. The relevant information display control unit 115 then displays information indicating a location of the first area identified by the relevant information obtaining unit 114 among the plurality of areas included in the floor map information 132 displayed by the map display control unit 113.

The image display control unit 112 refers to the line of flow information 140 including information regarding moving speeds of customers associated with areas and displays marks indicating movement routes (hereinafter also referred to as “lines of flow”) of one or more customers on the image displayed by the image display control unit 112. The line of flow information 140 is information generated by the movement history information 138, for example, and may be stored by the user or the like in the information storage area 130 in advance.

If a position on the marks is specified through the information reception unit 111, the movement history obtaining unit 116 obtains, in the line of flow information 140 stored in the information storage area 130, information regarding a customer (hereinafter referred to as a “first customer”) whose line of flow corresponds to a mark corresponding to the position specified through the information reception unit 111.

The moving speed calculation unit 117 refers to the three-dimensional mapping information 133, the line of flow object information 139 including information regarding lines of flow associated with the areas, and the line of flow information 140 obtained by the movement history obtaining unit 116 and calculates the moving speed of the first customer at a certain position (for example, any position specified by the user) ahead of the position on the marks specified through the information reception unit 111. The line of flow object information 139 may be stored by the user or the like in the information storage area 130 in advance.

The moving speed display control unit 118 displays the moving speed calculated by the moving speed calculation unit 117 on the floor image information 131 displayed by the image display control unit 112.

If any area is specified through the information reception unit 111, the route determination unit 119 determines whether the floor image information 131 displayed by the image display control unit 112 includes a route connecting the area specified through the information reception unit 111 to another area. The route connecting the area specified through the information reception unit 111 to another area may be, for example, a passage connecting a plurality of areas in the same area to each other or stairs or an elevator connecting areas included in different floors to each other.

If the route determination unit 119 determines that the floor image information 131 includes a route, the situation identification unit 120 refers to information in which purchase situations of products sold in the areas or the behavior of customers in the areas is associated with the areas and identifies a customer's purchase situation of products sold in the other area, the customer being one who has purchased a product sold in the area specified through the information reception unit 111. More specifically, the situation identification unit 120 refers to the store object information 135, the product information 136, and the POS information 137 and identifies a customer's purchase situation of products sold in the other area, the customer being one who has purchased a product sold in the area specified through the information reception unit 111.

In addition, if the route determination unit 119 determines that the floor image information 131 includes a route, the situation identification unit 120 refers to information in which purchase situations of products sold in the areas or the behavior of customers in the areas is associated with the areas and identifies the behavior of a customer in the other area, the customer being one who has purchased a product sold in the area specified through the information reception unit 111. More specifically, the situation identification unit 120 refers to the store object information 135, the product information 136, and the POS information 137 and identifies the behavior of a customer in the other area, the customer being one who has purchased a product sold in the area specified through the information reception unit 111.

The situation display control unit 121 displays, on the floor image information 131 displayed by the image display control unit 112, information regarding the purchase situations or information regarding the behavior identified by the situation identification unit 120.

### Outline of First Embodiment

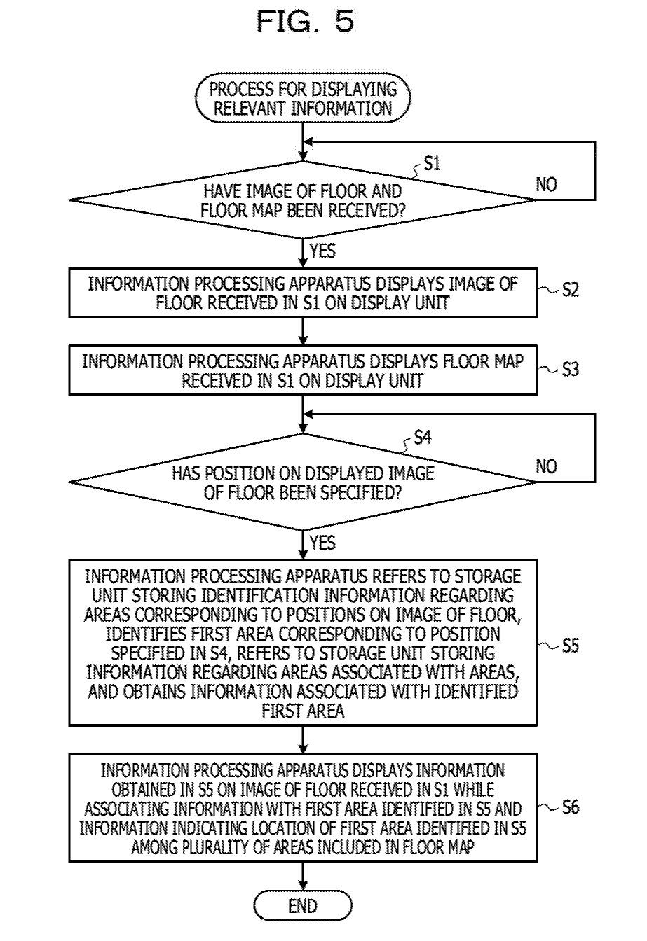

Next, an outline of a first embodiment will be described. FIGS. 5 to 7 are flowcharts illustrating an outline of a display control process according to the first embodiment.

Outline of Process for Displaying Relevant Information

First, an outline of a process (hereinafter referred to as a “process for displaying relevant information”) for displaying information regarding a position specified by the user in the display control process will be described.

As illustrated in FIG. 5, the information processing apparatus 1 waits until an image of a floor and a floor map are received (NO in S1). If an image of a floor and a floor map are received (YES in S1), the information processing apparatus 1 displays the image of the floor received in S1 on the display unit (S2). The information processing apparatus 1 then displays the floor map received in S1 on the display unit (S3).

Next, the information processing apparatus 1 waits until a position on the image of the floor displayed in S2 is specified (NO in S4). If a position on the image of the floor is specified (YES in S4), the information processing apparatus 1 refers to the information storage area 130 storing identification information regarding areas corresponding to positions on the image of the floor and identifies a first area corresponding to the position specified in S4 (S5).

The information processing apparatus 1 then displays the information obtained in S5 on the image of the floor received in S1 while associating the information with the first area identified in S5 (S6). The information processing apparatus 1 also displays information indicating a location of the first area identified in S5 among a plurality of areas included in the floor map (S6).

That is, the information processing apparatus 1 simultaneously displays, on the display unit, for example, a three-dimensional image (the image of the floor) indicating a state of the first area corresponding to the position specified by the user among the plurality of areas included in the floor and a two-dimensional image (floor map) indicating a positional relationship between the plurality of areas included in the floor. The information processing apparatus 1 then displays a position of the three-dimensional image (a position of the first area), for example, on the two-dimensional image. The information processing apparatus 1 also displays, for example, the information associated with the first area on the three-dimensional image at the position corresponding to the first area.

As a result, the information processing apparatus 1 enables the user to intuitively understand the position of the three-dimensional image, which is displayed on the display unit, on the floor. The information processing apparatus 1 also enables the user to intuitively understand the information associated with the first area. As a result, the user may efficiently analyze the in-store behavior of customers.

More specifically, in a retail chain store, for example, a person who determines the layout of stores (hereinafter simply referred to as “the person”) might not be able to visit all the stores because of locations of the stores and other restrictions. The person therefore is desired to obtain information regarding the stores and remotely determine the layout of the stores.

In this case, for example, the person uses the information processing apparatus 1 according to the present embodiment. As a result, even when the person remotely determines the layout of the stores, the person may obtain three-dimensional images of the stores and relevant information superimposed upon each other and notice details that would otherwise be noticed only when the person actually visited the stores.

Outline of Process for Displaying Moving Speed

Next, an outline of a process (hereinafter referred to as a “process for displaying a moving speed”) for displaying the moving speed of a customer at a position specified by the user in the display control process will be described.

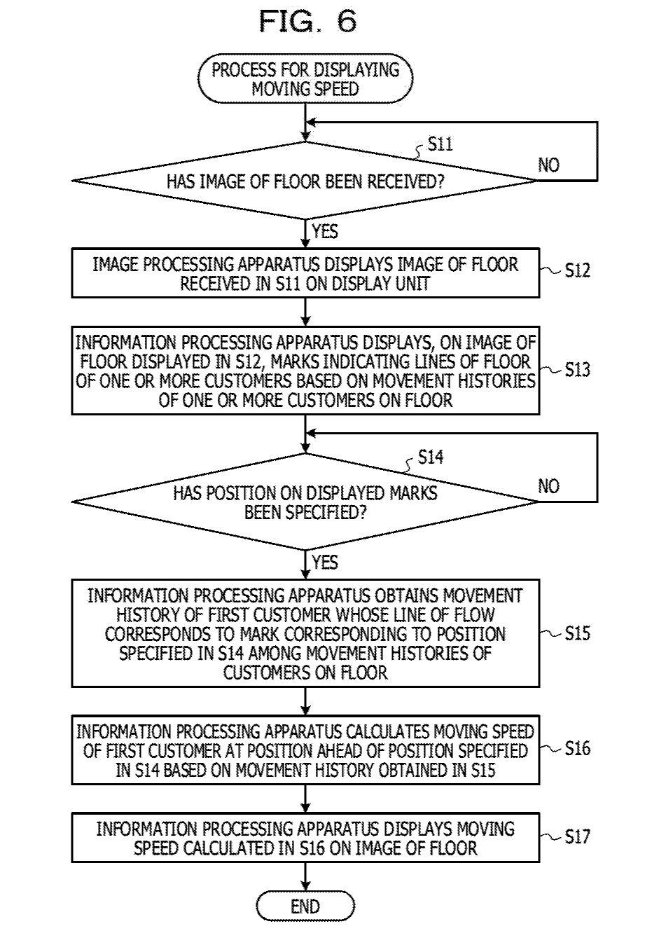

As illustrated in FIG. 6, the information processing apparatus 1 waits until an image of a floor is received (NO in S11). If an image of a floor is received (YES in S11), the information processing apparatus 1 displays the image of the floor received in S11 on the display unit (S12).

Next, the information processing apparatus 1 displays marks indicating lines of flow of one or more customers on the image of the floor displayed in S12 based on movement histories of the customers on the floor (S13).

The information processing apparatus 1 then waits until a position on the marks displayed in S13 is specified (NO in S14). If a position on the marks is specified (YES in S14), the information processing apparatus 1 obtains a movement history of a first customer whose line of flow corresponds to a mark corresponding to the position specified in S14 among the movement histories of the customers on the floor (S15).

Next, the information processing apparatus 1 calculates the moving speed of the first customer at a position ahead of the position specified in S14 based on the movement history obtained in S15 (S16). The information processing apparatus 1 then displays the moving speed calculated in S16 on the image of the floor (S17).

That is, if a position on the information (marks) indicating the lines of flow of the customers is specified, the information processing apparatus 1 calculates the moving speed of one or more customers at the position. The information processing apparatus 1 then simultaneously displays, on the display unit, the image of the floor and the calculated moving speed while associating the image of the floor and the moving speed.

As a result, the information processing apparatus 1 enables the user to intuitively understand the moving speed of a customer at a position specified by the user. The user thus understands that the customer is interested in products near positions at which the moving speed of the customer is low. The user also understands that the customer is not interested in any product near positions at which the moving speed of the customer is high. The user therefore identifies, for example, another floor whose information to be displayed next.

Outline of Process for Displaying Another Area Information

Next, a process (hereinafter referred to as a “process for displaying another area information”) for displaying a customer's purchase situation in another area or the like, the customer being one who has purchased a product arranged at a position specified by the user, in the display control process will be described.

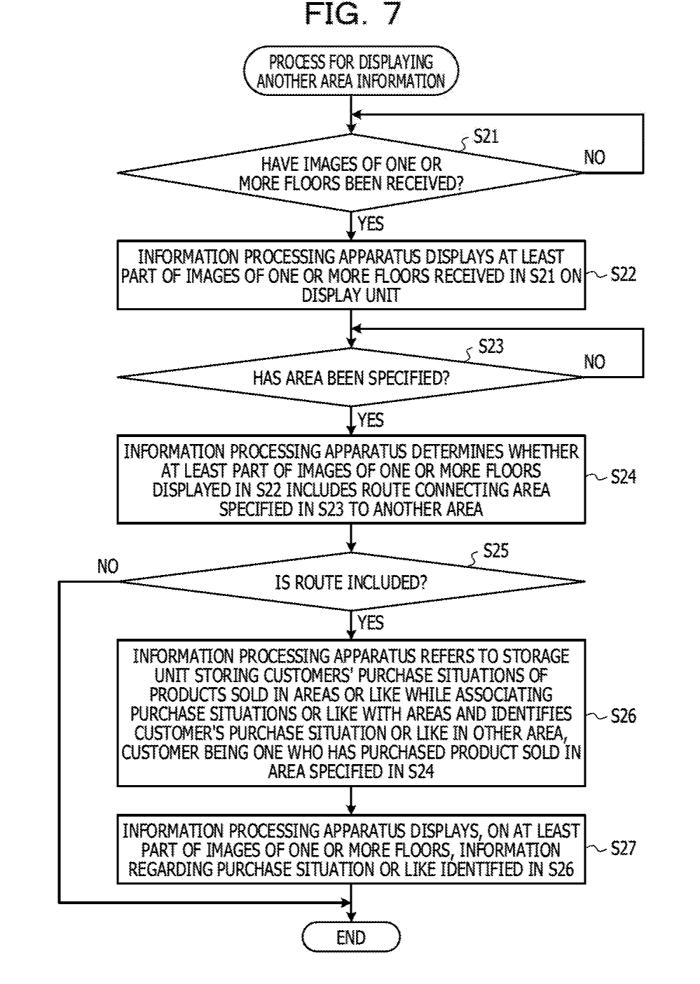

As illustrated in FIG. 7, the information processing apparatus 1 waits until images of one or more floors are received (NO in S21). If images of one or more floors are received (YES in S21), the information processing apparatus 1 displays at least part of the images of the one or more floors received in S21 on the display unit (S22).

The information processing apparatus 1 then waits until one of areas included in the one or more floors whose images have been received in S21 is specified (NO in S23). If one of the areas is specified (YES in S23), the information processing apparatus 1 determines whether the at least part of the images of the one or more floors displayed in S22 includes a route connecting the area specified in S23 to another area (S24).

If determining that the at least part of the images of the one or more floors includes a route connecting the area specified in S23 to another area (YES in S25), the information processing apparatus 1 refers to the storage unit 130 storing customers' purchase situations of products sold in the areas or the behavior of the customers in the areas while associating the purchase situations or the behavior with the areas and identifies a customer's purchase situation in the other area or the behavior of the customer in the other area, the customer being one who has purchased a product sold in the area specified in S24 (S26). The information processing apparatus 1 then displays, on the at least part of the images of the one or more floors displayed in S22, information regarding the purchase situation or information regarding the behavior identified in S26 (S27).

That is, if determining that an image of a floor displayed on the display unit includes a route connecting a specified area to another area, the information processing apparatus 1 simultaneously displays, on the display unit, the image of the floor and a customer's purchase situation or the behavior of the customer in the other area, the customer being one who has purchased a product sold in the specified area, while associating the image of the floor and the customer's purchase situation or the behavior of the customer with each other.

As a result, the information processing apparatus 1 enables the user to intuitively understand the behavior of a customer in another area, the customer being one who has purchased a product sold in an area specified by the user. The user therefore identifies, for example, another floor whose information is to be displayed next.

### Details of First Embodiment

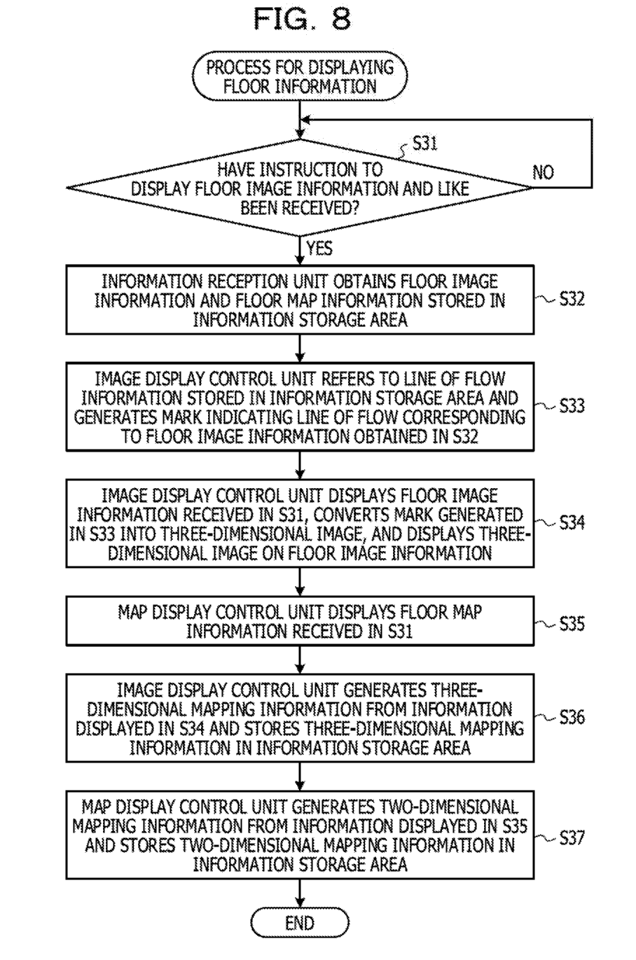

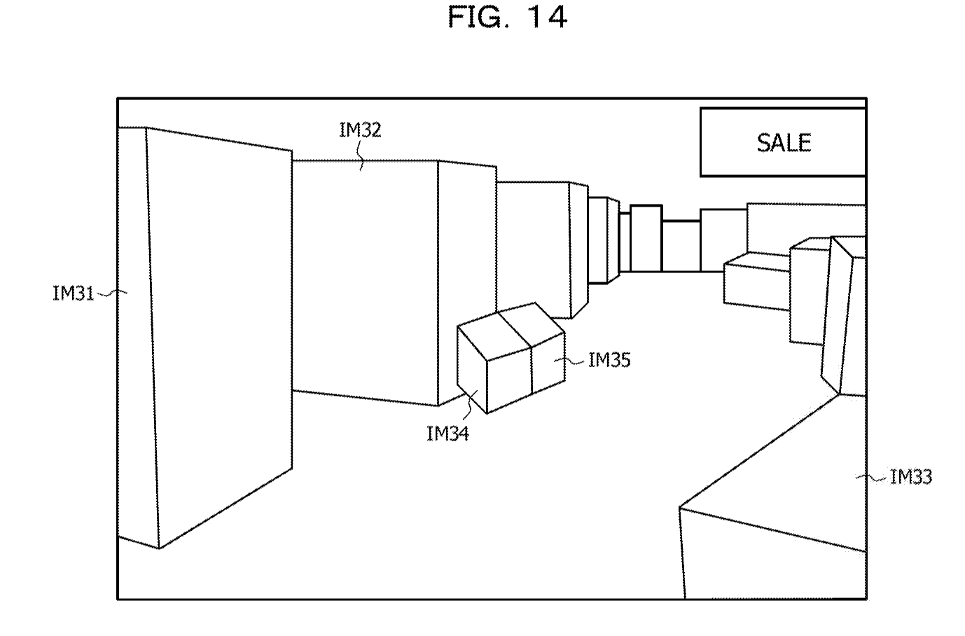

Next, details of the first embodiment will be described. FIGS. 8 to 13 are flowcharts illustrating details of the display control process according to the first embodiment. FIGS. 14 to 29 are diagrams illustrating the details of the display control process according to the first embodiment. The display control process illustrated in FIGS. 8 to 13 will be described with reference to FIGS. 14 to 29.

Process for Displaying Floor Information

First, a process (hereinafter referred to as a “process for displaying floor information”) for displaying the floor image information 131 and the floor map information 132 on the display device of a control terminal 3 will be described.

As illustrated in FIG. 8, the information reception unit 111 of the information processing apparatus 1 waits until an instruction to display the floor image information 131 and the floor map information 132 is received (NO in S31). More specifically, the information reception unit 111 waits the user inputs, through the control terminals 3, information for specifying a floor to be displayed on the display device of the control terminal 3, a position on the floor, and the like.

If an instruction to display the floor image information 131 and the floor map information 132 is received (YES in S31), the information reception unit 111 obtains the floor image information 131 and the floor map information 132 stored in the information storage area 130 (S32). Specific examples of the floor image information 131 and the floor map information 132 will be described hereinafter.

### Specific Example of Floor Image Information

First, the floor image information 131 will be described. FIG. 14 is a diagram illustrating a specific example of a screen at a time when the floor image information 131 has been displayed on the display device of the control terminal 3.

The screen illustrated in FIG. 14 includes, for example, shelves IM31, IM32, IM33, IM34, and IM35. That is, the screen illustrated in FIG. 14 indicates that, when a customer stands in a certain direction at a position at which the floor image information 131 has been captured, the customer's field of view includes the shelves IM31, IM32, IM33, IM34, and IM35. Description of other pieces of information included in the screen illustrated in FIG. 14 is omitted.

### Specific Example of Floor Map Information

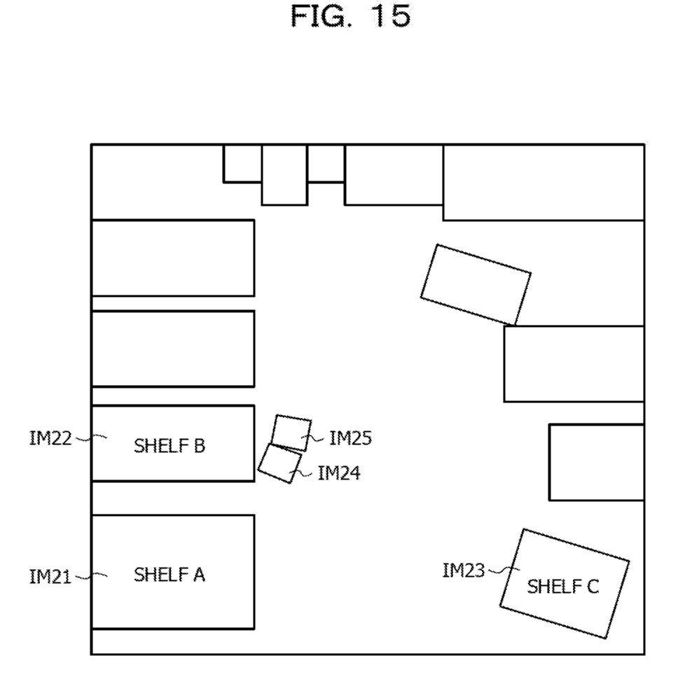

Next, the floor map information 132 will be described. FIG. 15 is a diagram illustrating a specific example of a screen at a time when the floor map information 132 has been displayed on the display device of the control terminal 3. The floor map information 132 illustrated in FIG. 15 is information regarding a floor map corresponding to a floor included in the floor image information 131 illustrated in FIG. 14.

The screen illustrated in FIG. 15 includes, for example, shelves IM21 (shelf A), IM22 (shelf B), IM23 (shelf C), IM24, and IM25 corresponding to the shelves IM31, IM32, IM33, IM34, and IM35, respectively, illustrated in FIG. 14. Description of other pieces of information included in the screen illustrated in FIG. 15 is omitted.

In FIG. 8, the image display control unit 112 of the information processing apparatus 1 refers to the line of flow information 140 stored in the information storage area 130 and generates a mark indicating a line of flow corresponding to the floor image information 131 obtained in S32 (S33). A specific example of the line of flow information 140 will be described hereinafter.

### Specific Example of Line of Flow Information

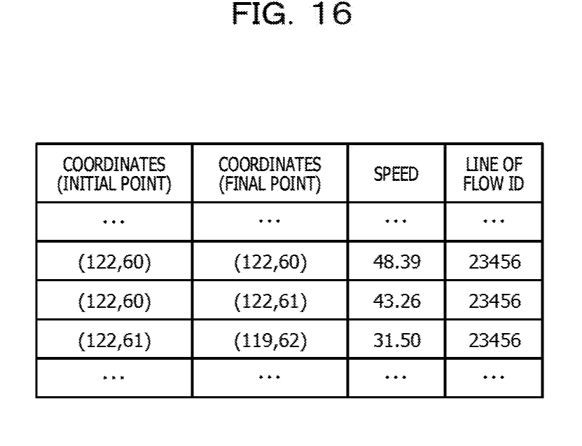

FIG. 16 is a diagram illustrating a specific example of the line of flow information 140.

The line of flow information 140 illustrated in FIG. 16 includes, as items thereof, “coordinates (initial point)”, which indicate a position at which a customer has arrived, and “coordinates (final point)”, which indicate a position at which the customer has arrived after the position indicated by “coordinates (initial point)”. The line of flow information 140 illustrated in FIG. 16 also includes, as items thereof, “speed”, which is an average speed between “coordinates (initial point)” and “coordinates (final point)”, and “line of flow ID”, which is a line of flow identifier (ID) for identifying a line of flow. In the line of flow information 140 illustrated in FIG. 16, information set for “coordinates (final point)” in a row is also set for “coordinates (initial point)” in a next row.

More specifically, in the line of flow information 140 illustrated in FIG. 16, “(120, 60)” is set for “coordinates (final point)”, “48.39 (m/min)” is set for “speed”, and “23456” is set for “line of flow ID” for information whose “coordinates (initial point)” is “(122, 60)”. In addition, in the line of flow information 140 illustrated in FIG. 16, “(120, 61)” is set for “coordinates (final point)”, “43.26 (m/min)” is set for “speed”, and “23456” is set for “line of flow ID” for information whose “coordinates (initial point)” is “(120, 60)”. Description of other pieces of information illustrated in FIG. 16 is omitted.

In S33, the image display control unit 112 refers to the line of flow information 140 illustrated in FIG. 16, for example, and generates, for each piece of information set for “line of flow ID”, a mark indicating a line of flow by connecting straight lines, each connecting a point set for “coordinates (initial point)” to a point set for “coordinates (final point)”.

More specifically, the image display control unit 112 refers to the line of flow information 140 illustrated in FIG. 16, for example, and generates a mark indicating a line of flow whose “line of flow ID” is “23456” by connecting a straight line from “(122, 60)” to “(120, 60)”, a straight line from “(120, 60)” to “(120, 61)”, a straight line from “(120, 61)” to “(119, 62)”, and the like.

Alternatively, the image display control unit 112 may generate marks indicating a plurality of lines of flow, for example, based on information regarding the plurality of lines of flow included in the line of flow information 140 illustrated in FIG. 16.

In FIG. 8, the image display control unit 112 displays the floor image information 131 received in S31, for example, on the display device of the control terminal 3. The image display control unit 112 then converts the mark indicating the line of flow generated in S33 into a three-dimensional image and displays the three-dimensional image on the floor image information 131 (S34). That is, the mark generated in S33 is a mark generated from the line of flow information 140, which is two-dimensional information. The floor image information 131, on the other hand, is a three-dimensional image. The image display control unit 112, therefore, displays the mark generated in S33 after converting the mark into a three-dimensional image.

The map display control unit 113 of the information processing apparatus 1 also displays the floor map information 132 received in S31 on the display device of the control terminal 3 (S35). A specific example when the mark generated in S33 has been displayed on the display device will be described hereinafter.

### Specific Example of Screen when Mark Generated in S33 has been Displayed

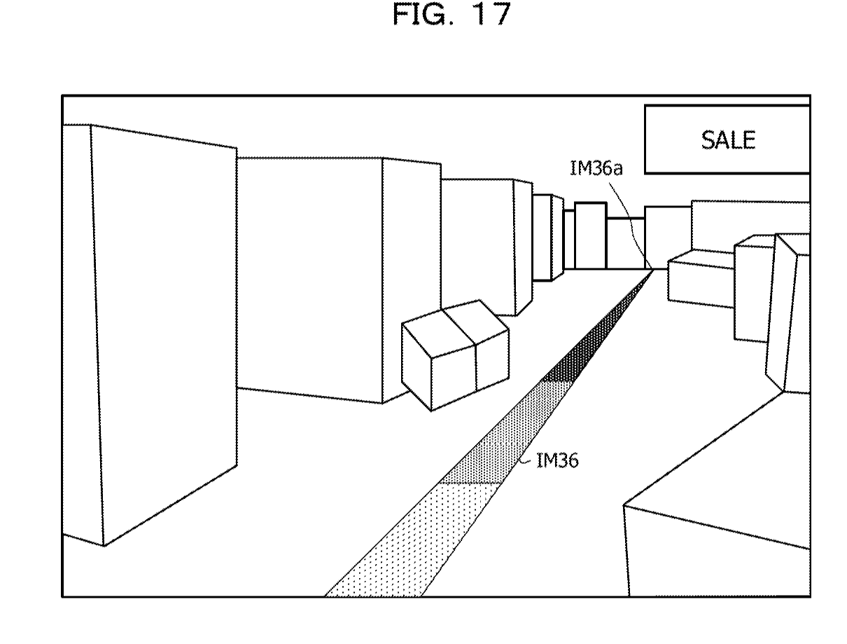

FIG. 17 is a diagram illustrating a specific example of a screen at a time when the mark generated in S33 has been displayed on the display device of the control terminal 3.

As illustrated in FIG. 17, the image display control unit 112 generates a mark IM36 by converting the mark generated in S33 into a three-dimensional image, for example, and displays the generated mark IM36 on the floor image information 131.

More specifically, the image display control unit 112 generates the mark IM36 such that, for example, a color of the mark IM36 becomes thicker in a movement direction of a customer. More specifically, as illustrated in FIG. 17, the image display control unit 112 may generate the mark IM36 such that, for example, the thickness of the color of the mark IM36 at two points that trisect the mark IM36, which extends from a bottom end of the floor image information 131 to a vanishing point IM36a, becomes one-third and two-thirds, respectively, of the thickness of the color of the mark IM36 at the vanishing point IM36a. In addition, as illustrated in FIG. 17, the image display control unit 112 may generate the mark IM36 such that, for example, the mark IM36 becomes transparent at the bottom end of the floor image information 131.

As a result, the image display control unit 112 enables the user to intuitively understand the behavior of a customer in a store.

Alternatively, when generating the mark in S33, the image display control unit 112 may, for example, change the color of the mark IM36 at different positions in accordance with the information set for “speed” in the line of flow information 140 illustrated in FIG. 16.

### Specific Example of Screen When S34 and S35 Have Been Performed

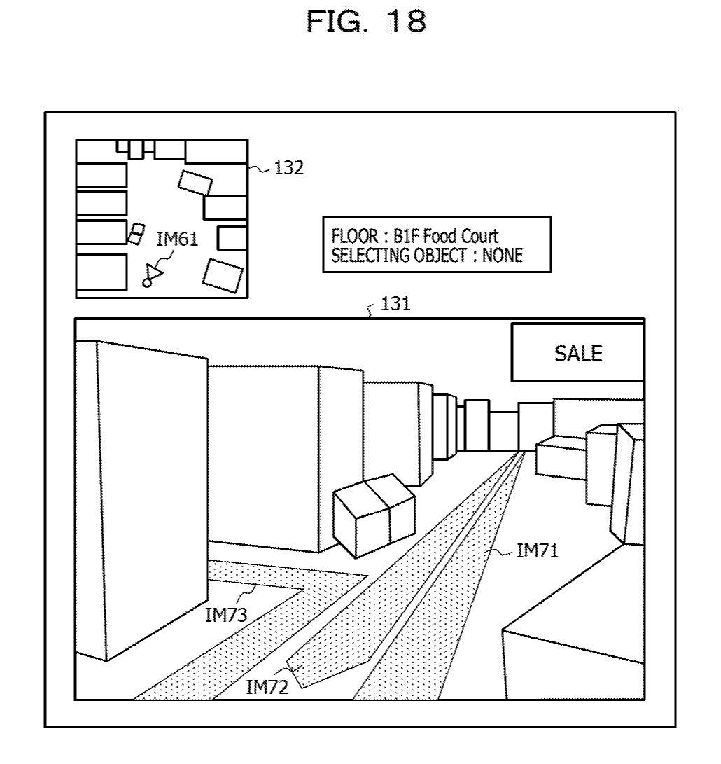

Next, a specific example of a screen when S34 and S35 have been performed will be described. FIG. 18 is a diagram illustrating a specific example of a screen at a time when S34 and S35 have been performed.

The floor image information 131 is displayed on the screen illustrated in FIG. 18 in middle and lower parts, and the floor map information 132 is displayed in an upper-left part. Marks IM71, IM72, and IM73 indicating lines of flow are displayed on the floor image information 131 illustrated in FIG. 18. A mark IM61 indicating a position at which and a direction in which the floor image information 131 illustrated in FIG. 18 has been captured is displayed on the floor map information 132 illustrated in FIG. 18.

The mark IM72 illustrated in FIG. 18 indicates a line of flow extending from a far point to a near point on the screen illustrated in FIG. 18. A leading end (near end) of the IM72 illustrated in FIG. 18, therefore, has an acute angle.

“Floor: B1F Food Court”, which indicates that a floor corresponding to the floor image information 131 is a food court in basement 1, is displayed in an upper part of the screen illustrated in FIG. 18. “Selected object: None”, which indicates that no object has been selected, is also displayed on the screen illustrated in FIG. 18.

As a result, the user intuitively understands a line of flow of a customer in an area included in the floor image information 131 by viewing the screen illustrated in FIG. 18.

In FIG. 8, the image display control unit 112 generates the three-dimensional mapping information 133 from the information displayed in S34 on the display device of the control terminal 3 and stores the three-dimensional mapping information 133 in the information storage area 130 (S36). The three-dimensional mapping information 133 associates the points included in the floor image information 131 displayed in S34 on the display device of the control terminal 3 and objects located at the points with each other. More specifically, for example, the image display control unit 112 may extract information used to generate the three-dimensional mapping information 133 by conducting an image analysis on the floor image information 131 and generates the three-dimensional mapping information 133 from the extracted information. In the following description, it is assumed that objects include, for example, shelves on which products are arranged, marks indicating lines of flow of customers (part of the marks), and routes connecting certain areas to other areas, such as stairs and elevators.

The map display control unit 113 generates the two-dimensional mapping information 134 from the information displayed in S35 on the display device of the control terminal 3 and stores the two-dimensional mapping information 134 in the information storage area 130 (S37). The two-dimensional mapping information 134 associates the points included in the floor map information 132 displayed in S35 on the display device of the control terminal 3 and objects located at the points with each other. More specifically, for example, the map display control unit 113 may extract information used to generate the two-dimensional mapping information 134 from the floor map information 132 by referring to positional information (not illustrated) indicating the positions of the objects and generate the two-dimensional mapping information 134 from the extracted information.

As a result, as described later, if a position on the floor image information 131 or the floor map information 132 displayed on the display device is specified, the information processing apparatus 1 identifies an object corresponding to the specified position. Specific examples of the three-dimensional mapping information 133 and the two-dimensional mapping information 134 will be described hereinafter.

### Specific Example of Three-Dimensional Mapping Information

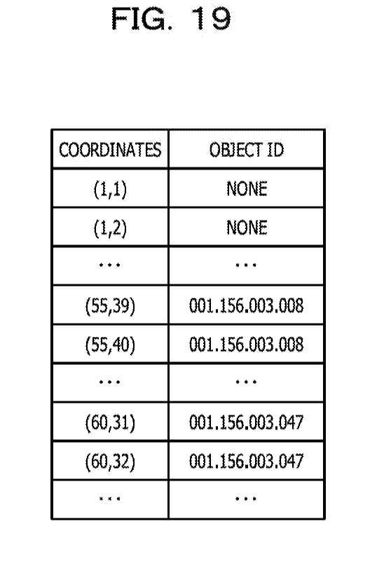

First, a specific example of the three-dimensional mapping information 133 will be described. FIG. 19 is a diagram illustrating a specific example of the three-dimensional mapping information 133.

The three-dimensional mapping information 133 illustrated in FIG. 19 is includes, as items thereof, for example, “coordinates”, which correspond to a point included in a screen of the display device of the control terminal 3, and “object ID”, which is used to identify an object located at the point. If there is no object at a point, “none” is set for “object ID”.

More specifically, in the three-dimensional mapping information 133 illustrated in FIG. 19, “none” is set for “object ID” of information whose “coordinates” are “(1, 1)”. In addition, in the three-dimensional mapping information 133 illustrated in FIG. 19, “001.156.003.008” is set for “object ID” of information whose “coordinates” are “(55, 39)”. Description of other pieces of information illustrated in FIG. 19 is omitted.

### Specific Example of Two-Dimensional Mapping Information

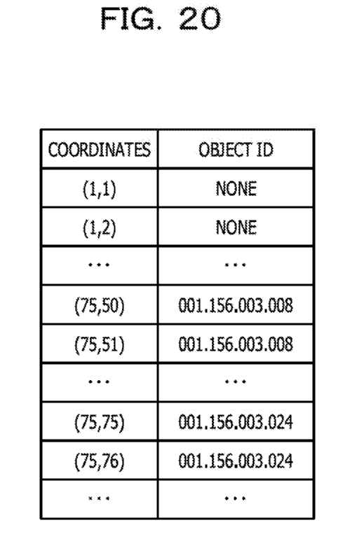

Next, a specific example of the two-dimensional mapping information 134 will be described. FIG. 20 is a diagram illustrating a specific example of the two-dimensional mapping information 134.

The two-dimensional mapping information 134 illustrated in FIG. 20 includes, as items thereof, for example, “coordinates”, which correspond to a point included in a screen displayed on the display device of the control terminal 3, and “object ID”, which is used to identify an object located at the point. If there is no object at a point, “none” is set for “object ID”.

More specifically, in the two-dimensional mapping information 134 illustrated in FIG. 20, “none” is set for “object ID” of information whose “coordinates” are “(1, 1)”. In addition, in the two-dimensional mapping information 134 illustrated in FIG. 20, “001.156.003.008” is set for “object ID” of information whose “coordinates” are “(75, 50)”. Description of other pieces of information illustrated in FIG. 20 is omitted.

The image display control unit 112 and the map display control unit 113 may generate the three-dimensional mapping information 133 corresponding to the floor image information 131 stored in the information storage area 130 and the two-dimensional mapping information 134 corresponding to the floor map information 132 stored in the information storage area 130, respectively, and store the three-dimensional mapping information 133 and the two-dimensional mapping information 134 in the information storage area 130 before receiving, in S31, an instruction to display the floor image information 131 and the like.

As a result, the information processing apparatus 1 more promptly starts the process at a time when a position has been specified on the floor image information 131 displayed on the display device of the control terminal 3.

Details of Process for Displaying Relevant Information

Next, details of the process for displaying relevant information will be described.

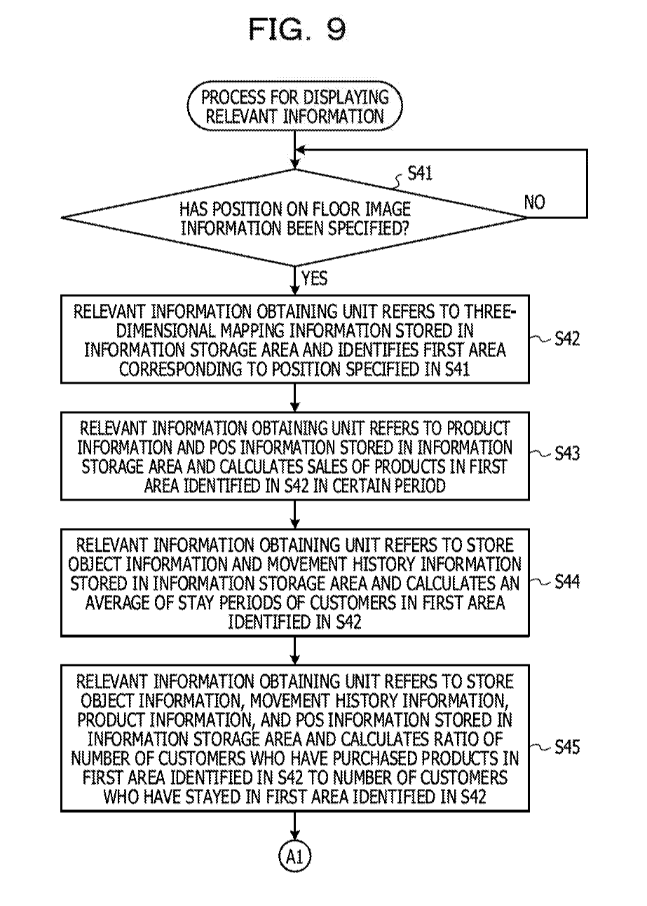

As illustrated in FIG. 9, the information reception unit 111 waits until a position on the floor image information 131 displayed on the display device of the control terminal 3 is specified (NO in S41). More specifically, the information reception unit 111 waits until the user specifies a position on the floor image information 131 through the control terminal 3.

If a position on the floor image information 131 is specified (YES in S41), the relevant information obtaining unit 114 of the information processing apparatus 1 refers to the three-dimensional mapping information 133 stored in the information storage area 130 and identifies a first area corresponding to the position specified in S41 (S42).

More specifically, if coordinates of the position specified in S41 are (55, 40), for example, the relevant information obtaining unit 114 identifies, in the three-dimensional mapping information 133 illustrated in FIG. 19, “001.156.003.008” set for “object ID” of information whose “coordinates” are “(50, 40)”. The relevant information obtaining unit 114 then determines, as the first area, an area in which an object whose “object ID” is “001.156.003.008”, for example, is located.

Alternatively, if a position on the floor map information 132 is specified in S41 through the information reception unit 111, the relevant information obtaining unit 114 may refer to the two-dimensional mapping information 134 stored in the information storage area 130 and identify a first area corresponding to the position specified in S41.

More specifically, if the coordinates of the position specified in S41 are (75, 51), for example, the relevant information obtaining unit 114 may identify, in the two-dimensional mapping information 134 illustrated in FIG. 20, “001.156.003.008” set for “object ID” of information whose “coordinates” are “(75, 51)”. The relevant information obtaining unit 114 may then identify, as the first area, an area in which the object whose “object ID” is “001.156.003.008” is located.

The relevant information obtaining unit 114 then refers to the product information 136 and the POS information 137 stored in the information storage area 130 and calculates the sales of products in the first area (products arranged in the first area) identified in S42 in a certain period (S43). Specific examples of the product information 136 and the POS information 137 will be described hereinafter.

### Specific Example of Product Information

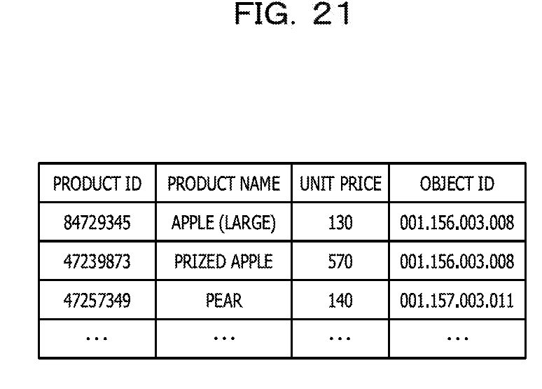

First, the product information 136 will be described. FIG. 21 is a diagram illustrating a specific example of the product information 136.

The product information 136 illustrated in FIG. 21 includes, as items thereof, “product ID”, which is used to identify a product, “product name”, for which a name of the product is set, “unit price”, for which a unit price of the product is set, and “object ID”, which is used to identify an object (a shelf or the like) on which the product is arranged.

More specifically, in the product information 136 illustrated in FIG. 21, “apple (large)” is set for “product name”, “130 (yen)” is set for “unit price”, “001.156.003.008” is set for “object ID” for information whose “product ID” is “84729345”. In addition, in the product information 136 illustrated in FIG. 21, “prized apple” is set for “product name”, “570 (yen)” is set for “unit price”, and “001.156.003.008” is set for “object ID” for information whose “product ID” is “47239873”. Description of other pieces of information illustrated in FIG. 21 is omitted.

### Specific Example of POS Information

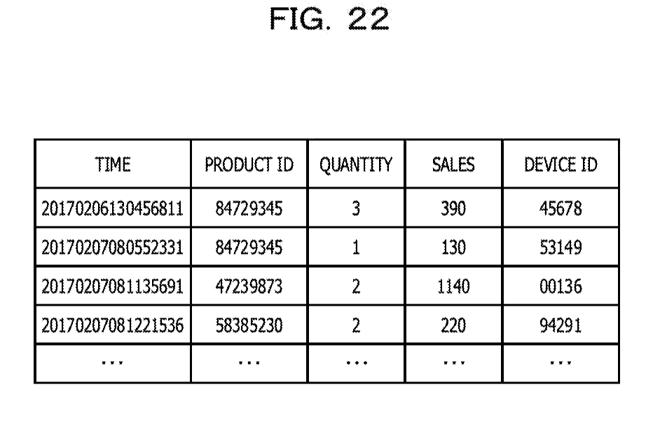

Next, the POS information 137 will be described. FIG. 22 is a diagram illustrating a specific example of the POS information 137.

The POS information 137 illustrated in FIG. 22 includes, as items thereof, “time”, for which a point in time at which a corresponding piece of information has been obtained is set, “product ID”, which is used to identify a product, “quantity”, for which the number of pieces of the product sold is set, “sales”, for which received money is set, and “device ID”, which is used to identify a wireless terminal carried by a customer who has purchased the product.

More specifically, in the POS information 137 illustrated in FIG. 22, “84729345” is set for “product ID”, “3 (pieces)” is set for “quantity”, “390 (yen)” is set for “sales”, and “45678” is set for “device ID” for information whose “time” is “20170206130456811”, which indicates 13:04:56.811 on Feb. 6, 2017. In addition, in the POS information 137 illustrated in FIG. 22, “84729345” is set for “product ID”, “1 (piece)” is set for “quantity”, “130 (yen)” is set for “sales”, and “53149” is set for “device ID” for information whose “time” is “20170207080552331”, which indicates 8:05:52.331 on Feb. 7, 2017. Description of other pieces of information illustrated in FIG. 22 is omitted.

If an area including “object ID” of “001.156.003.008” is identified in S42 as the first area, the relevant information obtaining unit 114 identifies, in the product information 136 illustrated in FIG. 21, “84729345” and “47239873”, which are set for “product ID” of information whose “object ID” is “001.156.003.008”. The relevant information obtaining unit 114 then refers to the POS information 137 illustrated in FIG. 22 and calculates, as the sales of products in the first area identified in S42, “1680 (yen)”, which is the sum of “390 (yen)”, “130 (yen)”, and “1140 (yen)” set for “sales” of information whose “product ID” is “84729345” or “47239873”.

Alternatively, for example, the relevant information obtaining unit 114 may refer only to information included in the POS information 137 illustrated in FIG. 22 whose “time” falls within a certain period (for example, a day) and calculate the sales of products in the first area identified in S42.

In FIG. 9, the relevant information obtaining unit 114 refers to the store object information 135 and the movement history information 138 stored in the information storage area 130 and calculates an average of stay periods of customers in the first area identified in S42 (S44). The store object information 135 and the movement history information 138 will be described hereinafter.

### Specific Example of Store Object Information

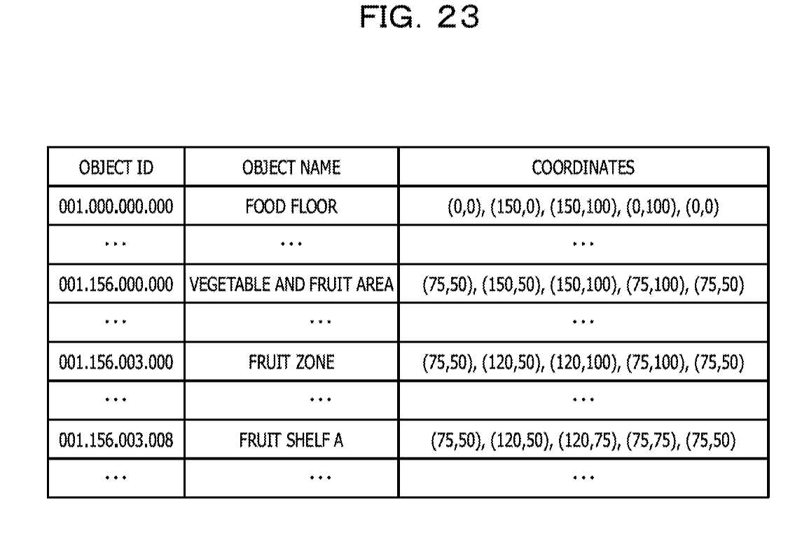

First, the store object information 135 will be described. FIG. 23 is a diagram illustrating a specific example of the store object information 135.

The store object information 135 illustrated in FIG. 23 includes, as items thereof, “object ID”, which is used to identify an object, “object name”, which is a name of the object, and “coordinates”, which indicate a position of the object. Latitude and longitude, for example, are set for “coordinates”.

More specifically, in the store object information 135 illustrated in FIG. 23, “food floor” is set for “object name” and “(0, 0), (150, 0), (150, 100), (0, 100), (0, 0)” is set for “coordinates” in information whose “object ID” is “001.000.000.000”. That is, in the store object information 135 illustrated in FIG. 23, it is indicated that the food floor is an area defined by a straight line connecting (0, 0) and (150, 0), a straight line connecting (150, 0) and (150, 100), a straight line connecting (150, 100) and (0, 100), and a straight line connecting (0, 100) and (0, 0). In addition, in the store object information 135 illustrated in FIG. 23, “vegetable and fruit area” is set for “object name” and “(75, 50), (150, 50), (150, 100), (75, 100), (75, 50)” is set for “coordinates” for information whose “object ID” is “001.156.000.000”. Description of other pieces of information illustrated in FIG. 23 is omitted.

### Specific Example of Movement History Information

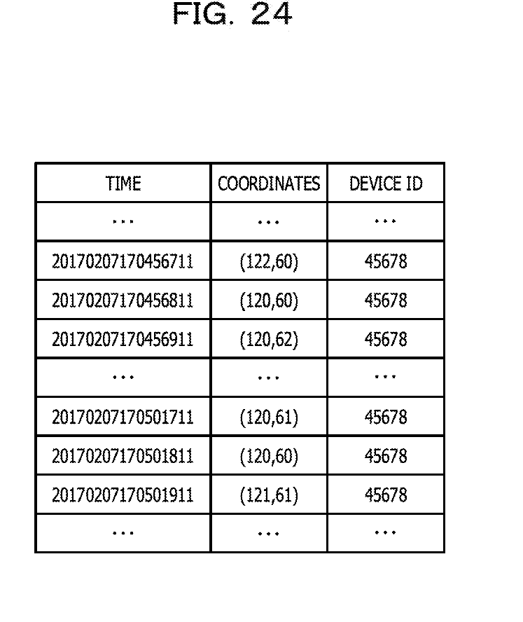

Next, the movement history information 138 will be described. FIG. 24 is a diagram illustrating a specific example of the movement history information 138. The movement history information 138 illustrated in FIG. 24 includes, as items thereof, “time”, which indicates a point in time at which a corresponding piece of information included in the movement history information 138 has been obtained, “coordinates”, which indicate a position of a wireless terminal carried by a customer, and “device ID”, which is used to identify the wireless terminal carried by the customer. Latitude and longitude, for example, are set for “coordinates”. The movement history information 138 may be generated for each wireless terminal carried by a customer.

More specifically, in the movement history information 138 illustrated in FIG. 24, “(122, 60)” is set for “coordinates” and “45678” is set for “device ID” for information whose “time” is “20170207170456711”, which indicates 17:04:56.711 on Feb. 7, 2017. In addition, in the movement history information 138 illustrated in FIG. 24, “(120, 60)” is set for “coordinates” and “45678” is set for “device ID” for information whose “time” is “20170207170456811”, which indicates 17:04:56.811 on Feb. 7, 2017. Description of other pieces of information illustrated in FIG. 24 is omitted.

If an area including “object ID” of “001.156.003.008” is identified in S42 as the first area, the relevant information obtaining unit 114 identifies, in the store object information 135 illustrated in FIG. 23, “(75, 50), (120, 50), (120, 75), (75, 75), (75, 50)”, which is information set for “coordinates” of the information whose “object ID” is “001.156.003.008”.

The relevant information obtaining unit 114 then refers to information whose “device ID” is “45678”, for example, included in the movement history information 138 illustrated in FIG. 24, and identifies information whose “time” is within a range of “20170207170456811” to “20170207170501811” as information whose “coordinates” are included in an area defined by a straight line connecting (75, 50) and (120, 50), a straight line connecting (120, 50) and (120, 75), a straight line connecting (120, 75) and (75, 75), and a straight line connecting (75, 75) and (75, 50). That is, the relevant information obtaining unit 114 identifies “5 (sec)”, which is from 17:04:56.811 on Feb. 7, 2017 to 17:05:01.811 on Feb. 7, 2017, as a first area stay period for the information whose “device ID” is “45678”. The relevant information obtaining unit 114 also calculates a first area stay period for each piece of information set for “device ID” in the movement history information 138 illustrated in FIG. 24.

Next, the relevant information obtaining unit 114 refers to the movement history information 138 illustrated in FIG. 24, for example, and identifies information whose “coordinates” are included in the area defined by the straight line connecting (75, 50) and (120, 50), the straight line connecting (120, 50) and (120, 75), the straight line connecting (120, 75) and (75, 75), and the straight line connecting (75, 75) and (75, 50). The relevant information obtaining unit 114 then identifies the number of different pieces of information set for “device ID” of the identified information as the number of customers who have stayed in the first area identified in S42.

Thereafter, the relevant information obtaining unit 114 divides the sum of first area stay periods for the different pieces of information set for “device ID” by the number of customers who have stayed in the first area to obtain an average of stay periods of the customers who have stayed in the first area.

In FIG. 9, the relevant information obtaining unit 114 refers to the store object information 135, the movement history information 138, the product information 136, and the POS information 137 stored in the information storage area 130 and calculates a ratio of the number of customers who have purchased products in the first area identified in S42 to the number of customers who have stayed in the first area identified in S42 (S45).

More specifically, in S42, if an area including “object ID” of “001.156.003.008” is identified as the first area, the relevant information obtaining unit 114 identifies, in the product information 136 illustrated in FIG. 21, “84729345” and “47239873”, which are information set for “product ID” of information whose “object ID” is “001.156.003.008”. The relevant information obtaining unit 114 then refers to the POS information 137 illustrated in FIG. 22, for example, and calculates the number of different pieces of information set for “device ID” of information whose “product ID” is “84729345” or “47239873” as the number of customers who have purchased products in the first area.

Thereafter, the relevant information obtaining unit 114 divides the calculated number of customers who have purchased products in the first area by the number of customers who have stayed in the first area (the number calculated in S44) to obtain a ratio of the number of customers who have purchased products in the first area identified in S42 to the number of customers who have stayed in the first area identified in S42.

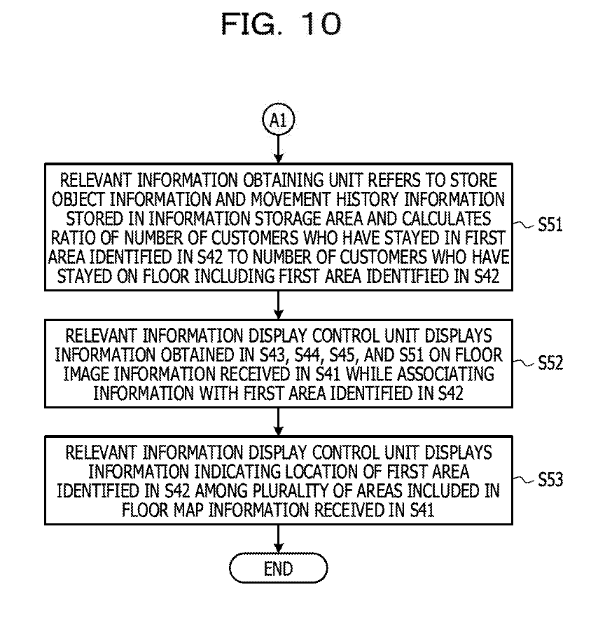

The relevant information obtaining unit 114 then, as illustrated in FIG. 10, refers to the store object information 135 and the movement history information 138 stored in the information storage area 130 and calculates a ratio of the number of customers who have stayed in the first area identified in S42 to the number of customers who have stayed on a floor including the first area identified in S42 (S51).

More specifically, in the store object information 135 illustrated in FIG. 23, “coordinates” of information whose “object name” is “fruit shelf A” (information whose “object ID” is “001.156.003.008”) is included in “coordinates” of information whose “object name” is “food floor” (information whose “object ID” is “001.000.000.000”). If an area including “object ID” of “001.156.003.008” is identified in S42 as the first area, therefore, the relevant information obtaining unit 114 identifies an area including objects whose “object name” is “food floor”, for example, as a floor including the first area. The relevant information obtaining unit 114 then identifies, in the store object information 135 illustrated in FIG. 23, “(0, 0), (150, 0), (150, 100), (0, 100), (0, 0)”, which is information set for “coordinates” of the information whose “object ID” is “001.000.000.000”.

The relevant information obtaining unit 114 also refers to the movement history information 138 illustrated in FIG. 24, for example, and identifies information whose “coordinates” are included in the area defined by the straight line connecting (0, 0) and (150, 0), the straight line connecting (150, 0) and (150, 100), the straight line connecting (150, 100) and (0, 100), and the straight line connecting (0, 100) and (0, 0). The relevant information obtaining unit 114 also identifies the number of different pieces of information set for “device ID” of the identified information as the number of customers who have stayed on the floor including the first area identified in S42.

The relevant information obtaining unit 114 then divides the number of customers (the number calculated in S44) who have stayed in the first area identified in S42 by the number of customers who have stayed on the floor including the first area identified in S42 to obtain a ratio of the number of customers who have stayed in the first area identified in S42 to the number of customers who have stayed on the floor including the first area identified in S42.

In FIG. 10, the relevant information display control unit 115 of the information processing apparatus 1 displays the information obtained in S43, S44, S45, and S51 on the floor image information 131 received in S41 while associating the information with the first area identified in S42 (S52). The relevant information display control unit 115 displays information indicating a location of the first area identified in S42 among a plurality of areas included in the floor map information 132 received in S41 (S53). A specific example of the display screen of the control terminal 3 when S52 and S53 have been performed will be described hereinafter.

### Specific Example of Screen when S52 and S53 have been Performed

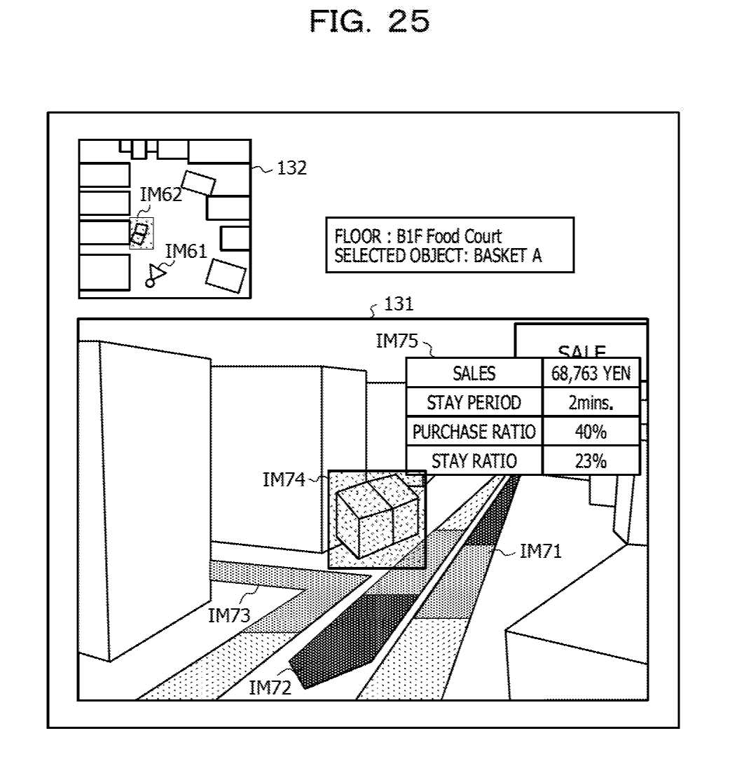

FIG. 25 is a diagram illustrating a specific example of a screen at a time when S52 and S53 have been performed.

Hatching IM74 is displayed on the screen illustrated in FIG. 25 in the first area of the floor image information 131 identified in S42. Display information IM75 regarding the first area is associated with the hatching IM74 on the screen illustrated in FIG. 25 (S52).

More specifically, the relevant information display control unit 115 displays, on the floor image information 131 as the display information IM75 regarding the first area, information indicating that “sales” are “\68,763” (the information calculated in S43) and information indicating that “stay period” is “2 mins” (the information calculated in S44). The relevant information display control unit 115 also displays, on the floor image information 131 as the display information IM75 regarding the first area, information indicating that “purchase ratio” is “40%” (the information calculated in S45) and information indicating that “stay ratio” is “23%” (the information calculated in S51).

In addition, hatching IM62 is displayed on the screen illustrated in FIG. 25 in the first area of the floor map information 132 identified in S42 (S53).

As a result, the information processing apparatus 1 enables the user to intuitively understand the information associated with the first area. The user, therefore, may efficiently analyze the in-store behavior of customers.

Details of Process for Displaying Moving Speed

Next, details of the process for displaying a moving speed will be described.

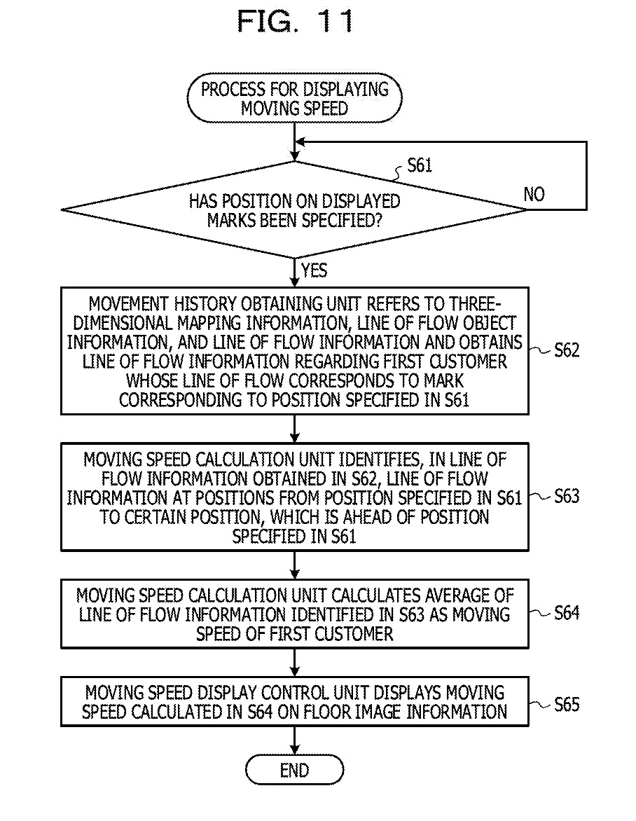

As illustrated in FIG. 11, the information reception unit 111 waits until a position on marks displayed on the display device of the control terminal 3 (marks indicating lines of flow) is specified (NO in S61). More specifically, the information reception unit 111 waits until the user specifies a position on the marks through the control terminal 3.

If a position on the marks is specified (YES in S61), the movement history obtaining unit 116 refers to the three-dimensional mapping information 133, the line of flow object information 139, and the line of flow information 140 and obtains line of flow information 140 regarding a first customer whose line of flow corresponds to a mark corresponding to the position specified in S61 in the line of flow information 140 stored in the information storage area 130 (S62). A specific example of the line of flow object information 139 will be described hereinafter.

### Specific Example of Line of Flow Information

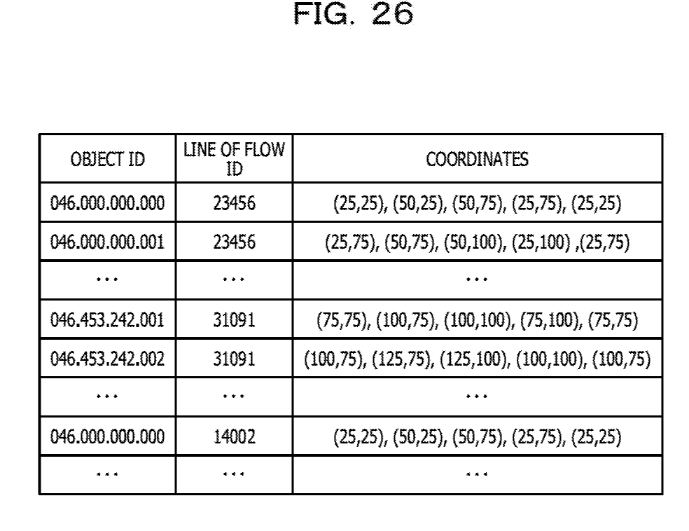

FIG. 26 is a diagram illustrating a specific example of the line of flow object information 139.

The line of flow object information 139 illustrated in FIG. 26 includes, as items thereof, “object ID”, which is used to identify an object, “line of flow ID”, which is used to identify a line of flow, and “coordinates”, which indicate a position of the object. Latitude and longitude, for example, are set for “coordinates”.

More specifically, in the line of flow object information 139 illustrated in FIG. 26, “23456” is set for “line of flow ID” and “(25, 25), (50, 25), (50, 75), (25, 75), (25, 25)” is set for “coordinates” for information whose “object ID” is “046.000.000.000”. That is, the line of flow object information 139 illustrated in FIG. 26 indicates that a line of flow whose “line of flow ID” is “23456” includes an area defined by a straight line connecting (25, 25) and (50, 25), a straight line connecting (50, 25) and (50, 75), a straight line connecting (50, 75) and (25, 75), and a straight line connecting (25, 75) and (25, 25).

In addition, in the line of flow object information 139 illustrated in FIG. 26, “23456” is set for “line of flow ID” and “(25, 75), (50, 75), (50, 100), (25, 100), (25, 75)” is set for “coordinates” for information whose “object ID” is “046.000.000.001”. Description of other pieces of information illustrated in FIG. 26 is omitted.

In S62, the movement history obtaining unit 116 refers to the three-dimensional mapping information 133 illustrated in FIG. 19, for example, and identifies an object ID corresponding to coordinates of the position specified in S61. The movement history obtaining unit 116 then refers to the line of flow object information 139 illustrated in FIG. 26, for example, and identifies a line of flow ID corresponding to the identified object ID. Thereafter, the movement history obtaining unit 116 obtains line of flow information 140 including the identified line of flow ID, for example, from the line of flow information 140 illustrated in FIG. 16.

In FIG. 11, the moving speed calculation unit 117 of the information processing apparatus 1 identifies, in the line of flow information 140 obtained in S62, line of flow information 140 at positions from the position specified in S61 to a certain position, which is ahead of the position specified in S61 (S63).

More specifically, the moving speed calculation unit 117 identifies, in the line of flow object information 139 illustrated in FIG. 26, for example, coordinates corresponding to the object ID identified in S62. The moving speed calculation unit 117 then identifies, in the line of flow information 140 obtained in S62, for example, line of flow information 140 (hereinafter referred to as “first line of flow information 140a”) whose “coordinates (initial point)” and “coordinates (final points)” are coordinates included in an area defined by the identified coordinates. The moving speed calculation unit 117 also identifies, in the line of flow information 140 stored in the information storage area 130, for example, line of flow information 140 (hereinafter referred to as “second line of flow information 140b”) whose “coordinates (initial point)” indicate a position 2 meters away from “coordinates (initial point)” of the first line of flow information 140a. The moving speed calculation unit 117 also identifies, in the line of flow information 140 stored in the information storage area 130, for example, line of flow information 140 located between the first line of flow information 140a and the second line of flow information 140b.

The moving speed calculation unit 117 then calculates an average of the line of flow information 140 identified in S63 as the moving speed of the first customer (S64).

More specifically, the moving speed calculation unit 117 calculates, as the moving speed of the first customer, an average of information set for “speed” of the line of flow information 140 identified in S63.

The moving speed display control unit 118 of the information processing apparatus 1 then displays the moving speed calculated in S64 on the floor image information 131 (S65). A specific example of a screen of the display device when S65 has been performed will be described hereinafter.

### Specific Example of Screen when S65 has been Performed

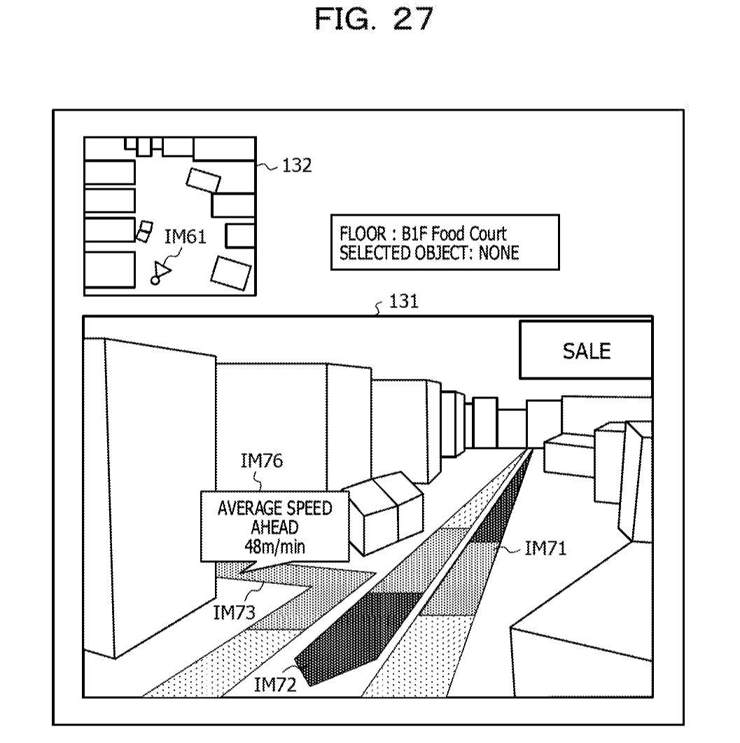

Next, a specific example of the screen when S65 has been performed will be described. FIG. 27 is a diagram illustrating a specific example of the screen at a time when S65 has been performed.

Display information IM76 regarding the position on the marks specified in S61 is associated with the position specified in S61 on the screen illustrated in FIG. 27 (S65).

More specifically, the moving speed display control unit 118 displays, on the floor image information 131 as the display information IM76 regarding the position specified in S61, information indicating that the average speed ahead of the position specified in S61 is “48 m/min”.

As a result, the information processing apparatus 1 enables the user to intuitively understand the moving speed of a customer at a position specified by the user. The user, therefore, may determine that, for example, the customer is interested in products near positions at which the moving speed of the customer is low. The user may also determine that, for example, the customer is not interested in any product near positions at which the moving speed of the customer is high. The user may therefore identify, for example, another floor whose information to be displayed next.

Details of Process for Displaying Another Area Information

Next, details of the process for displaying another area information will be described.

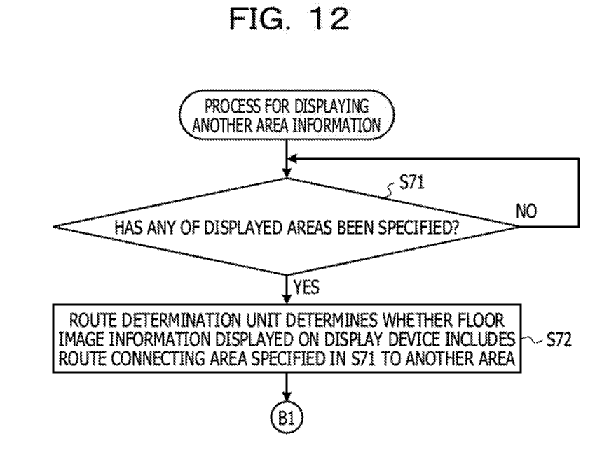

As illustrated in FIG. 12, the information reception unit 111 waits until any of areas displayed on the display device of the control terminal 3 is specified (NO in S71). More specifically, the information reception unit 111 waits until the user specifies, through the control terminals 3, an area displayed on the display device of the control terminal 3.

If an area is specified (YES in S71), the route determination unit 119 of the information processing apparatus 1 determines whether the floor image information 131 displayed on the display device of the control terminal 3 includes a route connecting the area specified in S71 to another area (S72).

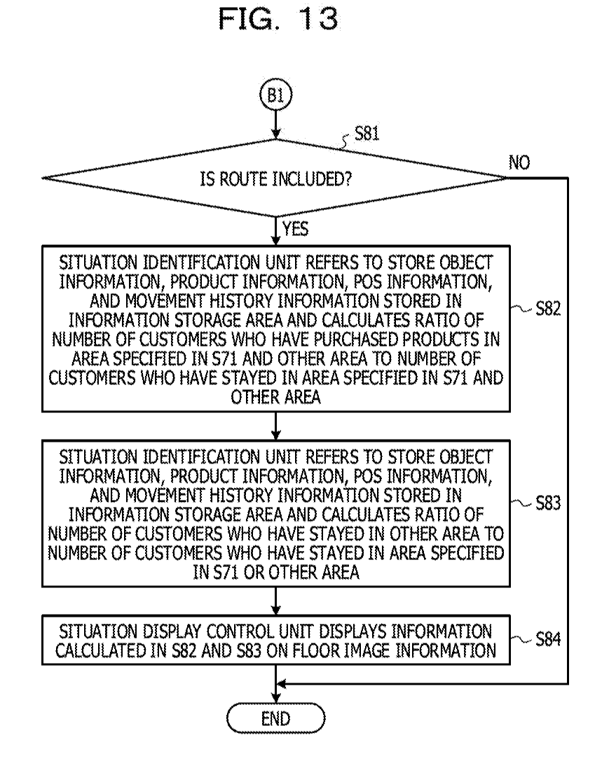

If, as illustrated in FIG. 13, it is determined that the floor image information 131 includes such a route (YES in S81), the situation identification unit 120 of the information processing apparatus 1 refers to the store object information 135, the product information 136, the POS information 137, and the movement history information 138 stored in the information storage area 130 and calculates a ratio of the number of customers who have purchased products in the area specified in S71 and the other area to the number of customers who have stayed in the area specified in S71 and the other area (S82).

More specifically, the situation identification unit 120 refers to the store object information 135 illustrated in FIG. 23 and identifies coordinates (hereinafter referred to as “coordinates of the specified area”) corresponding to object IDs of objects included in the area specified in S71. The situation identification unit 120 refers to the store object information 135 illustrated in FIG. 23 and also identifies coordinates (hereinafter referred to as “coordinates of the other area”) corresponding to object IDs of objects included in the other area (an area connected by the route identified in S72).

Next, the situation identification unit 120 refers to the movement history information 138 illustrated in FIG. 24 and identifies device IDs corresponding to both coordinates included in the specified area and coordinates included in the other area. Alternatively, the situation identification unit 120 may identify device IDs of wireless terminals carried by customers who have stayed in both the area specified in S71 and the other area for a certain period of time or longer. More specifically, the situation identification unit 120 may identify, among the device IDs set for the movement history information 138 illustrated in FIG. 24, device IDs corresponding to a certain number or more of pieces of information for which coordinates included in the specified area are set and a certain number or more of pieces of information for which coordinates included in the other area are set. The situation identification unit 120 then determines, as the number of customers who have stayed in both the area specified in S71 and the other area, the number of different device IDs identified in the above process.

The situation identification unit 120 then refers to the product information 136 illustrated in FIG. 21 and identifies product IDs (hereinafter referred to as “product IDs in the specified area”) corresponding to the object IDs included in the area specified in S71. The situation identification unit 120 refers to the product information 136 illustrated in FIG. 21 and also identifies product IDs (hereinafter referred to as “product IDs in the other area”) corresponding to the object IDs included in the other area.

Next, the situation identification unit 120 refers to the POS information 137 illustrated in FIG. 22 and identifies device IDs corresponding to both the product IDs in the specified area and the product IDs in the other area. The situation identification unit 120 then determines, as the number of customers who have purchased products in the area specified in S71 and the other area, the number of different device IDs identified in the above process.

Thereafter, the situation identification unit 120 calculates a ratio of the number of customers who have purchased products in the area specified in S71 and the other area to the number of customers who have stayed in the area specified in S71 and the other area.

In FIG. 13, the situation identification unit 120 refers to the store object information 135, the product information 136, the POS information 137, and the movement history information 138 stored in the information storage area 130 and calculates a ratio of the number of customers who have stayed in the other area to the number of customers who have stayed in the area specified in S71 or the other area (S83).

More specifically, the situation identification unit 120 refers to the movement history information 138 illustrated in FIG. 24, for example, and identifies device IDs corresponding to coordinates included in the area specified in S82. The situation identification unit 120 then identifies the number of different device IDs.

The situation identification unit 120 refers to the movement history information 138 illustrated in FIG. 24 and also identifies device IDs corresponding to coordinates included in the other area identified in S82. The situation identification unit 120 then identifies the number of different pieces of device IDs.

Thereafter, the situation identification unit 120 calculates the sum of the number of different pieces of IDs identified in the above process as the sum of the number of customers who have stayed in the area specified in S71 and the number of customers who have stayed in the other area.

The situation identification unit 120 calculates a ratio of the number of customers who have stayed in the other area to the number of customers who have stayed in the area specified in S71 and the other area by dividing the number of customers who have stayed in both the area specified in S71 and the other area (the number calculated in S82) by the sum of the number of customers who have stayed in the area specified in S71 and the number of customers who have stayed in the other area.

In FIG. 13, the situation display control unit 121 of the information processing apparatus 1 displays the information calculated in S82 and S83 on the floor image information 131 (S84). Specific examples of a screen of the display device when S84 has been performed will be described hereinafter.

### Specific Examples of Screen when S84 has been Performed

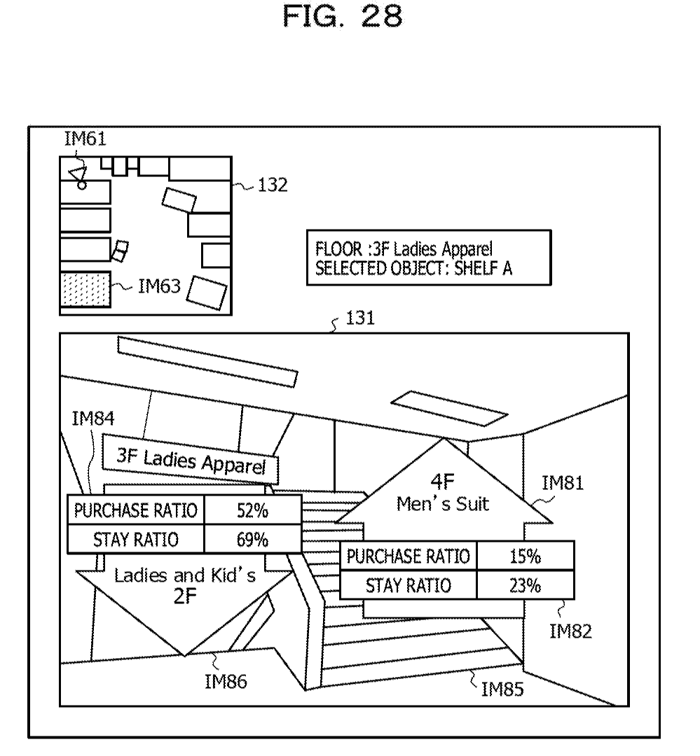

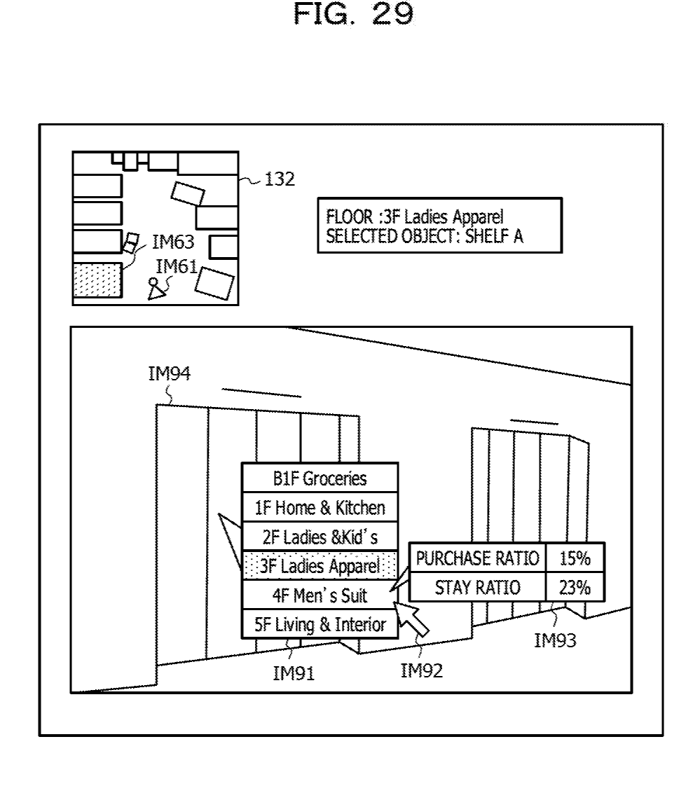

Next, specific examples of a screen when S84 has been performed will be described. FIGS. 28 and 29 are diagrams illustrating specific examples of the screen at a time when S84 has been performed. More specifically, in the example illustrated in FIG. 28, a route to another area is stairs. In the example illustrated in FIG. 29, a route to another area is an elevator.

First, the screen illustrated in FIG. 28 will be described. In the floor map information 132 on the screen illustrated in FIG. 28, hatching IM63 is displayed in the area specified in S71. In the floor image information 131 on the screen illustrated in FIG. 28, an arrow IM82 including “4F”, which indicates an upper floor, and “Men's Suits”, which indicates that men's suits are sold on the upper floor, are displayed in a part corresponding to stairs IM85 leading to the upper floor. In addition, in the floor image information 131 on the screen illustrated in FIG. 28, an arrow IM83 including “2F”, which indicates a lower floor, and “Ladies' and Kids'”, which indicate that women's and kids' clothes are sold on the lower floor, are displayed in a part corresponding to stairs IM86 leading to the lower floor.

In the floor image information 131 on the screen illustrated in FIG. 28, information IM82 indicating that “purchase ratio”, which indicates the ratio calculated in S82, is “15%” and that “stay ratio”, which indicates the ratio calculated in S83, is “23%” is displayed in the arrow IM81. In addition, in the floor image information 131 illustrated in FIG. 28, information IM84 indicating that “purchase ratio”, which indicates the ratio calculated in S82, is “52%” and that “stay ratio”, which indicates the ratio calculated in S83, is “69%” is displayed in the arrow IM83.

“Floor: 3F Ladies' Apparel”, which indicates that the floor included in the floor image information 131 is a third floor on which women's clothes are sold, is displayed on the screen illustrated in FIG. 28. In addition, “Selected object: Shelf A”, which indicates that an area including shelf A has been selected in S71 is displayed on the screen illustrated in FIG. 28.

Next, the screen illustrated in FIG. 29 will be described. More specifically, in the floor map information 132 on the screen illustrated in FIG. 29, the hatching IM63 is displayed in the area specified in S71 as in FIG. 28. In the floor image information 131 on the screen illustrated in FIG. 29, “3F Ladies' Apparel”, which indicates the floor included in the floor image information 131, and “B1F Groceries”, “1F Home & Kitchen”, and the like, which indicate other floors connected by an elevator IM94, are displayed in a part corresponding to the elevator IM94.

As illustrated in FIG. 29, if the user moves an arrow IM92 to “4F Men's Suits” using the control terminal 3, for example, information IM93 indicating that “purchase ratio”, which indicates the ratio calculated in S82, is “15%” and that “stay ratio”, which indicates the ratio calculated in S83, is “23%” is displayed and associated with “4F Men's Suits”.

“Floor: 3F Ladies' Apparel”, which indicates that the floor included in the floor image information 131 is the third floor on which women's clothes are sold, is displayed on the screen illustrated in FIG. 29 as in FIG. 28. In addition, “Selected object: Shelf A”, which indicates that an area including shelf A has been selected in S71, is displayed on the screen illustrated in FIG. 29.

As a result, the information processing apparatus 1 enables the user to intuitively understand the behavior of a customer in another area, the customer being one who has purchased a product sold in an area specified by the user. The user may therefore identify another floor whose information is to be displayed next.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
receiving an image of a floor included in a store and a floor map including a plurality of areas included in the floor;
displaying the received image and the received floor map on a screen of a display device;
specifying, upon a reception of a designation of a position in the image, a first area, in the plurality of areas, corresponding to the designated position based on correspondence information stored in a first memory, the correspondence information indicating a correspondence between a plurality of positions in the image and the plurality of areas included in the floor;
obtaining information associated with the first area from a second memory, the second memory storing pieces of information in association with the plurality of areas respectively;
displaying the obtained information on the displayed image in association with the first area; and
displaying, on the screen, information indicating a position of the first area in the floor map.

2. The non-transitory computer-readable storage medium according to claim 1, wherein
the obtaining obtains information on sales of products located in the first area in a predetermined period.

3. The non-transitory computer-readable storage medium according to claim 1, wherein
the obtaining obtains information on an average of stay periods of a person who have stayed in the first area.

4. The non-transitory computer-readable storage medium according to claim 1, wherein
the obtaining obtains information on a ratio of a number of persons who have purchased a product in the first area to the number of customers who have stayed in the first area as the information associated with the first area.

5. The non-transitory computer-readable storage medium according to claim 1, wherein
the obtaining obtains information on a ratio of a number of persons who have stayed in the first area to a number of persons who have stayed on the floor.

6. The non-transitory computer-readable storage medium according to claim 1, wherein, the process further comprising:
displaying, on the image, a mark indicating movement routes of one or more persons based on movement history information of the one or more customers on the floor;
obtaining movement history information of a first person whose movement route corresponds to a mark corresponding to the designated position;
calculating a moving speed of the first customer at a position ahead of the designated position on the movement route based on the obtained movement history information; and
displaying information indicating the calculated moving speed on the image.

7. The non-transitory computer-readable storage medium according to claim 6, wherein
the movement history information includes information indicating a plurality of positions on the floor through which the one or more persons have moved; and wherein
the displaying the mark includes:
identifying the movement routes of the one or more persons based on the information indicating the plurality of positions; and
displaying the mark indicating the identified movement routes.

8. The non-transitory computer-readable storage medium according to claim 7, wherein
the movement history information includes moving speeds of the one or more persons at the plurality of positions on the floor through which the one or more persons have moved, and
wherein the calculating includes:
identifying, among moving speeds included in the movement history information of the first person, moving speeds corresponding to positions from the designated position to a position ahead of the designated position on the moving route; and
calculating an average of the identified moving speeds as the moving speed of the first customer.

9. The non-transitory computer-readable storage medium according to claim 1, wherein
the process further comprises:
determining, upon the reception of the designation, whether the received image includes a route from the first area to another area; wherein
the obtaining obtains, upon a determination that the received image includes the route from the first area to the another area, information regarding a behavior of one or more persons who have moved the route at the another area based on behavior information stored in a third memory, the behavior information indicating behaviors of the one or more persons at each of the plurality of areas; and
the displaying the obtained information displays information indicating the specified behavior of the one or more persons on the image.

10. The non-transitory computer-readable storage medium according to claim 9, wherein
the information indicating the specified behavior is displayed at a position corresponding to the route in the image.

11. The non-transitory computer-readable storage medium according to claim 9, wherein
the information regarding the behavior of the one or more persons indicates a ratio of the number of persons who have stayed in the another area to a number of persons who have stayed in at least one of the first area and the another area.

12. The non-transitory computer-readable storage medium according to claim 9,
wherein the route includes a route from the first area to another area on a same floor and a route from the first area to another area on different floors.

13. The non-transitory computer-readable storage medium according to claim 1, wherein
the process further comprises:
determining, upon the reception of the designation, whether the received image includes a route from the first area to another area; wherein
the obtaining obtains, upon a determination that the received image includes the route from the first area to the another area, information regarding a purchase situation of one or more persons who has moved the route at the another area based on purchase information stored in a third memory, the purchase information indicating purchase situations of the one or more persons at each of the plurality of areas; and
the displaying the obtained information displays information indicating the specified purchase situation of the one or more persons on the image.

14. The non-transitory computer-readable storage medium according to claim 13, wherein
the information indicating the specified purchase situation is displayed at a position corresponding to the route in the image.

15. The non-transitory computer-readable storage medium according to claim 13, wherein
the information regarding the purchase situation of the one or more persons indicates a ratio of the number of persons who have purchased a product located in the first area and a product located in the another area to a number of persons who have stayed in the first area and the another area.

16. The non-transitory computer-readable storage medium according to claim 13,
wherein the route includes a route from the first area to another area on a same floor and a route from the first area to another area on different floors.

17. A display control apparatus comprising:
a memory; and
a processor coupled to the memory and the processor configured to execute a process, the process including:
receiving an image of a floor included in a store and a floor map including a plurality of areas included in the floor;
displaying the received image and the received floor map on a screen of a display device;
specifying, upon a reception of a designation of a position in the image, a first area, in the plurality of areas, corresponding to the designated position based on correspondence information stored in a first memory, the correspondence information indicating a correspondence between a plurality of positions in the image and the plurality of areas included in the floor;
obtaining information associated with the first area from a second memory, the second memory storing pieces of information in association with the plurality of areas respectively;
displaying the obtained information on the displayed image in association with the first area; and
displaying, on the screen, information indicating a position of the first area in the floor map.

18. A display control method executed by a computer, the display control method comprising:
receiving an image of a floor included in a store and a floor map including a plurality of areas included in the floor;
displaying the received image and the received floor map on a screen of a display device;
specifying, upon a reception of a designation of a position in the image, a first area, in the plurality of areas, corresponding to the designated position based on correspondence information stored in a first memory, the correspondence information indicating a correspondence between a plurality of positions in the image and the plurality of areas included in the floor;
obtaining information associated with the first area from a second memory, the second memory storing pieces of information in association with the plurality of areas respectively;
displaying the obtained information on the displayed image in association with the first area; and
displaying, on the screen, information indicating a position of the first area in the floor map.
